(19) United States
(12) Patent Application Publication
(10) Pub. No.: US 2025/0182232 A1
(43) Pub. Date: Jun. 5, 2025

(54) UNIVERSAL FARE PAYMENT AND COLLECTION SYSTEM

(71) Applicants: Moua Branckay Cesar Serge MANGO, Saint Martin (FR); Melvin Jason Moua MANGO, Weston, FL (US)

(72) Inventor: Moua Branckay Cesar Serge MANGO, Saint Martin (FR)

(21) Appl. No.: 18/965,122

(22) Filed: Dec. 2, 2024

Related U.S. Application Data
(60) Provisional application No. 63/604,950, filed on Dec. 1, 2023.

(51) Int. Cl. G06Q 50/40; G06Q 20/32; G06Q 20/40

(52) U.S. Cl. CPC G06Q 50/40; G06Q 20/3276; G06Q 20/3278; G06Q 20/409; G06Q 2240/00

(57) ABSTRACT

The Universal Fare Payment system allows global travelers to access public transportation and toll roads, bridges, and tunnels in a ubiquitous fashion. This solution enables a global traveler to purchase transportation system services and other related services throughout the world using a mobile application or contactless card. The system utilizes contactless access technologies that are associated with smart card readers in use today and those planned for the future. This system also allows the user to utilize and communicate with multiple smart home platforms and devices at once, as well as allowing the user to access public transportation technologies to plan trips and purchase tickets from those devices.

### FIELD

This application claims priority to U.S. Ser. No. 63/604,950, filed Dec. 1, 2023, the contents of which are herein incorporated by reference. The present teaching relates generally to fare payment, collection, and smart device integration systems, and more particularly to a universal fare payment, collection, and smart device integration system.

### BACKGROUND

It is common for individuals to travel via public transportation. For example, individuals may use subway or bus systems or use a taxicab service. Individuals may buy a transportation pass for using a public transportations system.

However, currently available public transportation systems have problems that need to be solved. For example, it is not possible to board different public transportation systems with one pass, since each transport authority has its own closed fare payment and collection system. Therefore, individuals are frequently inconvenienced with needing to buy multiple travel passes for traveling on multiple transportation systems.

The following four systems attempt to solve the above problems but have their own technical problems and issues:

Masabi simplifies ticketing and streamlines fare collection, validation, and management for public transportation providers. However, Masabi provides a white labeled solution that integrates specifically on a 1-1 basis. A white labeled solution/product is one where the manufacturer (Masabi in this instance) creates a product and sells it to a retailer, who will put their own branding on the product, often without making any other changes or modifications to the product. For a new public transportation authority to implement Masabi's solution-they must work directly with Masabi to create a customized white label mobile application that only works with one specific public transport authority (PTA). The limitation to their offering is that it does not provide an overarching platform to allow users to ride various PTAs via the same mobile app. In other words, the white labeled mobile app will only be compatible with the PTA it was specifically built for. To allow the user to gain access to another PTA, a separate Masabi mobile app would be required to be built.

Gemalto Pure is an off the shelf payment application from Gemalto and is fully compliant with Europay Mastercard and Visa (EMV) standards. Gemalto Pure offers white label services for closed loop card issuers. However, the Gemalto Pure offering is complex in nature which would require and include major infrastructure and custom development to integrate with fully compliant EMV standards. The limitation again is that using this white label solution only provides access to a single PTA and not universal access to a myriad of readers. Furthermore, Gemalto Pure does not provide the implementation of a mobile app.

Apple/Android/Samsung Pay allow for users to upload their credit cards digitally to communicate with near field communications (NFC) directly to point of sales. However, the limitation is that most card readers in PTAs today do not directly accept these protocols. Thus, when dealing with a card reader that does not support these NFC payment methods, no access will be granted. In other words, using these protocols alone will only provide access to a small subset of PTAs and not universal access.

GlobeSherpa (now Moovel transit) is a suite of white-labeled mobile ticketing and payment solutions. GlobeSherpa helps transit apps connect with the rest of the transportation ecosystem. However, the limitation again comes down to the inability of a single application to integrate universally over all the PTAs globally.

Accordingly, there exists a need for an effective universal fare payment and collection system that solves the problems and overcomes the limitations of the above-described systems.

Some of the technologies used herein are as follows:

Handshake: In telecommunications, a handshake is an automated process of negotiation between two participants through the exchange of information that establishes the protocols of a communication link at the start of the communication, before full communication begins. The handshaking process serves to establish rules for communication between two devices. Handshaking can negotiate parameters that are acceptable to equipment and systems at both ends of the communication channel, including information transfer rate, coding alphabet, parity, interrupt procedure, and other protocol or hardware features.

Bluetooth Low Energy (BLE): Bluetooth is a short-range wireless technology standard that is used for exchanging data between fixed and mobile devices over short distances using Ultra High Frequency radio waves in the 2.402 GHz to 2.48 GHz frequency range. Ordinary Bluetooth technology can handle a lot of data but quickly consumes battery life and is costly. Bluetooth Low Energy (BLE) is used for applications that do not need to exchange large amounts of data and can run on battery power for years at a cheaper cost. In BLE, the packets are exchanged through a Bluetooth channel that has at least 1 MHz in bandwidth. BLE maintains a connection with a reader for milliseconds, whereas ordinary Bluetooth technology can maintain the connection from seconds to hours. Ordinary Bluetooth can transfer and receive more data than BLE but also uses more energy. BLE is a common Bluetooth technology for ticketing payments as it maintains the connection with the reader for a smaller amount of time, thereby reducing the possibility of malicious interference. BLE devices are incompatible with Bluetooth ones, as they use different Frequency-Hopping Spread Spectrums (FHSS). BLE remains in sleep mode except for when a connection is initiated. BLE utilizes data rates of around 1 Mb/s which allows for shorter connection times.

Near Field Communication (NFC): Near Field Communication is a set of communication protocols that enables communication between two electronic devices over a distance of 4 cm or less. NFC is based on inductive coupling between two antennas present on NFC-enabled devices communicating in one or both directions, using a frequency of 13.56 MHz in the globally available unlicensed radio frequency ISM band using the ISO/IEC 18000-3 air interface standard at data rates ranging from 106 to 424 kbit/s. NFC uses an initiator and a target. The initiator actively generates an RF field that can power a passive target. This enables NFC targets to take very simple for factors such as unpowered tags, stickers, key fobs, or cards. NFC peer-to-peer communication is possible, so long as both devices are powered.

NFC Data Exchange Format (NDEF): NFC Data Exchange Format is an NFC data format created to implement data transferal and reception using NFC hardware, specifically with NFC-enabled Android devices.

Host Card Emulation (HCE): Host Card Emulation is the software architecture that provides exact virtual representation of various electronic identity cards using only software. HCE enables mobile applications running on supported operating systems to offer payment card and access card solutions independently of third parties while leveraging cryptographic processes traditionally used by hardware-based secure elements without the need for a physical secure element. This technology enables the merchants to offer payment cards solutions more easily through mobile closed-loop contactless payment solutions, offers real-time distribution of payment cards and allows for an easy deployment scenario that does not require changes to the software inside payment terminals.

Payment Service Provider (PSP): A Payment Service Provider is a third-party company that assists companies by facilitating electronic payments. PSPs act as intermediaries between consumers and retailers.

Trusted Service Manager (TSM): A Trusted Service Manager acts as a neutral broker that sets up business agreements and technical connections with mobile network operators, mobile device manufacturers, or other entities controlling the secure element on mobile devices. TSMs enable service providers to distribute and manage their contactless applications remotely by allowing access to the Secure Element in NFC-enabled devices.

Radio-Frequency Identification (RFID): Radio-Frequency Identification utilizes electromagnetic fields to automatically identify and track tags attached to objects. An RFID system includes a radio transponder, a radio receiver, and transmitter. When triggered by an electromagnetic interrogation pulse from a nearby RFID reader device, the tag transmits digital data back to the reader. Passive tags are powered by energy from the RFID reader's interrogating radio waves. Active tags are powered by a battery and thus can be read at a greater range from the RFID reader, up to 100 meters.

Hypertext Transfer Protocol (HTTP): The Hypertext Transfer Protocol is an application layer protocol in the Internet protocol suite model for distributed, collaborative, hypermedia information systems. HTTP functions as a request-response protocol in the client-server model. The client submits an HTTP request message to the server. The server, which provides resources such as HTML files and other content or performs other functions on behalf of the client, returns a response message to the client. The response contains completion status information about the request and may also contain requested content in its message body.

MiFARE4Mobile: MiFARE4Mobile is the most widely adopted contactless technology on the market. MiFARE4Mobile provides Mobile Network Operators (MNOs) with an interoperable programming interface to remotely provision and manage MiFARE4Mobile based services in embedded secure elements and SIM cards, doing so over the air (OTA). MiFARE4Mobile products comply with international standard ISO/IEC 14443 Type A, which is a standard used by most contactless smart cards, using the 13.56 MHz contactless smart card standard.

MiFARE 2GO: MiFARE 2GO is a digitized MiFARE system that allows travelers to use their mobile device as their ticket or pass for public transportation. Works with all NFC-enabled devices. Can be used with existing MiFARE infrastructure, including but not limited to MiFARE DESFire and MiFARE Plus.

FeliCa: FeliCa is a contactless RFID smart card system created by Sony in Japan for use in electronic money cards. This system uses an encryption key generated dynamically during mutual authentication. FeliCa and ISO/IEC 14443 Type C international standard are very similar with only a few significant differences between the standards. ISO/IEC 18092 (NFC) uses similar modulation operations with Manchester coding at 212 kbits/s in the 13.56 MHz range. Communication can occur within 10 cm.

Mobile FeliCa Platform: The Mobile FeliCa Platform is a platform compatible with mobile devices, developed based on FeliCa. The Mobile FeliCa Platform is able to utilize online payment services such as Apple Pay and Google Pay.

Calypso: An electronic ticketing standard for microprocessors for contactless smart cards. This standard provides multiple sources of compatible products and allows for interoperability between several transport operators in the same area. The standard is reliant on a microprocessor smartcard and RFID for the contactless interface. Calypso and ISO/IEC 14443 Type B international standard are very similar with only a few significant differences between the standards.

CIPURSE: CIPURSE is an open security standard for transit fare collection systems. It makes use of smart card technologies and additional security measures. CIPURSE products comply with ISO/IEC 7816 smart card standard, as well as the 128-bit Advanced Encryption Standard and the ISO/IEC 14443 Protocol. CIPURSE works with all NFC-enabled devices.

CIPURSE V2: CIPURSE V2 is a set of requirements and use cases for developing and deploying CIPURSE-secured transit fare mobile apps for NFC-enabled devices.

CIPURSE 4Move: CIPURSE 4Move is an integration software for the integration of various CIPURSE V2 compatible software. Applications include weekly/seasonal cards for automatic fare collection, event ticketing, access control, and micropayments. It can store up to eight custom applications.

Blockchain: A blockchain is a distributed ledger with growing lists of records (blocks) that are securely linked together via cryptographic hashes (similar to a unique ID). A blockchain is a chain of blocks, wherein the blocks contain time-stamped digital records of any transactions or data exchanges on the distributed network of computers. A block has its cryptographic hash. Every block contains its hash and the previous block's hash, along with data, which connects the blockchain.

Digital Currency: Digital Currency is any currency, money, or money-like asset that is primarily managed, stored, or exchanged on digital computer systems, especially over the internet. Types of digital currency include cryptocurrencies, virtual currencies, and central bank digital currencies.

Cryptocurrency: Cryptocurrency is a digital currency designed to work as a medium of exchange through a computer network that is not reliant on any central authority, such as governments or banks, to uphold or maintain it. Individual coin/token ownership records are stored in a digital ledger (usually blockchain).

Central Bank Digital Currency: A Central Bank Digital Currency (CBDC) is a form of universally accessible digital currency in a nation and holds the same value as the country's physical currency. CBDC is held in the form of tokens and is established through the central bank within a country rather than a commercial bank or other entity.

Venmo: Venmo is a mobile payment service that allows users to send and receive funds electronically. Users can link bank accounts, debit cards, or credit cards to facilitate money transfers. Venmo can either be used via a mobile app or on their website. Upon request, Venmo will provide users with a Venmo Mastercard that is linked to the user's Venmo account balance. Venmo is currently only available to residents of the United States.

Zelle: Zelle is a mobile payment service that allows users to send and receive funds electronically. Users can link bank accounts to facilitate money transfers. Zelle can either be used via a mobile app or on the website of a participating banking institution.

Cash App: Cash App is a mobile payment service that allows users to send and receive funds electronically, as well as purchase/sell cryptocurrency and trade stocks. Users can link bank accounts to facilitate money transfers. Cash App can be used via a mobile app. Cash App is currently only available to residents of the United States and the United Kingdom, and international money transfers are unavailable.

Dwolla: Dwolla is a white labeled mobile payment service that allows users to send and receive funds electronically. A company/business who purchases Dwolla's software can edit it such that it looks like they created it and can tailor it to their specific needs. Dwolla is currently only available to residents of the United States.

WeChat Pay: WeChat Pay (also known as “Weixin Pay”) is a mobile payment and digital wallet service based in China that allows users to make mobile payments and online transactions. Users can link bank accounts, debit cards, or credit cards to facilitate money transfers.

Alipay: Alipay is a mobile payment and digital wallet service operated by Alibaba™. Alipay is used in smartphones with their Alipay Wallet app. QR code payment codes are used for local in-store payments. The Alipay app also provides features such as credit card bill payments, bank account managements, P2P transfer, prepay mobile phone top-up, bus and train ticket purchases, food orders, vehicles for hire, insurance selections and a digital identification document storage.

Samsung Pay: Samsung Pay is a mobile payment and digital wallet service operated by Samsung that allows users to make electronic payments using compatible Samsung phones and devices using NFC technology, as well as magnetic secure transmission for magnetic strip payment terminals. Users can link bank accounts, debit cards, or credit cards to facilitate money transfers. Samsung Pay is currently available in dozens of countries worldwide.

Apple Pay: Apple Pay is a mobile payment and digital wallet service operated by Apple™ that allows users to make electronic payments using compatible Apple™ phones and devices using NFC technology. Users can link bank accounts, debit cards, or credit cards to facilitate money transfers. Apple Pay is currently available in dozens of countries worldwide.

Google Pay: Google Pay is a mobile payment and digital wallet service operated by Google™ that allows users to make electronic payments using compatible Google phones and devices using NFC and HCE technologies. Users can link bank accounts, debit cards, or credit cards to facilitate money transfers. Google Pay is currently available in dozens of countries worldwide.

Amazon Alexa: Amazon Alexa is a virtual assistant and smart speaker technology owned by Amazon™ since 2013. Amazon Alexa is capable of voice interaction with users, music playback, creating to-do lists, setting alarms, controlling smart devices, and obtaining real time information, such as news and weather information. Amazon Alexa is also capable of installing third party software to gain additional functionalities. This list is exemplary of the functionalities of Amazon Alexa and is not exhaustive. The Amazon Alexa App, a companion app to the Amazon Alexa virtual assistant, is available for download on Apple™'s Appstore, Google™'s Google Play Store, and Amazon™'s Appstore.

Google Nest: Google Nest, previously known as Google Home, is a virtual assistant and smart speaker technology created by Google™ in 2016. Google Nest is capable of voice interaction with users, music playback, creating to-do lists, setting alarms, controlling smart devices, and obtaining real time information, such as news and weather information. Google Nest is also capable of installing third party software to gain additional functionalities. This list is exemplary of the functionalities of Google Nest and is not exhaustive. The Google Home App, a companion app to the Google Nest virtual assistant, is available for download on Apple™'s Appstore and Google™'s Google Play Store.

Apple Siri: Apple Siri (Siri) is a virtual assistant technology owned by Apple™ since 2010. Siri is capable of voice interaction with users, performing phone actions, checking basic information, scheduling events and reminders, handling device settings, searching the internet, navigating areas, finding information on entertainment, and is able to engage with iOS-integrated apps. This list is exemplary of the functionalities of Siri and is not exhaustive. Siri is available on all Apple™ devices capable of running the iOS 11 operating system and newer.

Ring Doorbell: Ring Doorbell (Ring) is a smart doorbell system that includes a camera and microphone, along with normal doorbell capabilities. Ring allows users to not only hear the doorbell when rang, but also allows users to remotely see who is ringing the doorbell, talk to the person/people ringing the doorbell, and to review footage captured by Ring.

Closed Circuit Television (CCTV): Closed Circuit Television is a method of video surveillance that is widely implemented around the world.

Biometrics: Biometrics are body measurements and calculations related to human characteristics.

Biometric Identifiers: Biometric identifiers are distinctive, physical, and measurable characteristics used to label and describe individuals. Examples of these biometric identifiers include but are not limited to fingerprints, palm veins, face, DNA, palm print, hand geometry, iris, retina, scent, voice, ears, and gait.

Biometric Identification: Biometric identification is a method of identification that utilizes biometric identifiers to identify individuals. Since biometric identifiers are unique to individuals, they are more reliable in verifying identity than token and knowledge-based methods, such as passwords and security questions. There are three steps in the use of biometric identification to identify a person. The first step is to generate reference models for all of the users of the system and store those models in a database. The second step is to take samples of the person the system is attempting to identify, and to match the samples with the reference models to generate the genuine and imposter scores and calculate the threshold. The third step is to test the data and compare it against the data stored regarding the user's face.

Multimodal Biometric Identification: Multimodal biometric identification systems use multiple sensors or biometrics to identify a person. These systems can obtain sets of information from the same biometric or information from different biometrics.

Facial Recognition: Facial recognition is a technology capable of matching a human face from a digital image or a video from against a database of faces. Facial recognition works by pinpointing and measuring facial features from a given image. Facial recognition systems attempt to identify a human face, which is three-dimensional and changes in appearance with lighting and facial expression, based on its two-dimensional image. To accomplish facial recognition, these systems perform four steps. The first step is facial detection, in which the system delineates the face from the image background. The second step is facial alignment, in which the face is aligned to account for face pose, image size, and photographic properties, such as illumination and grayscale. The third step is facial feature extraction, in which the features of the face, such as eyes, nose, and mouth, are pinpointed and measured in the image to represent the face. The fourth step is to match the face against a database of faces.

HP Smart: HP Smart is an app created by Hewlett Packard™ (HP™) that lets users control their smart devices made by HP™ from their computer or mobile device.

Air Taxi: An Air Taxi is a small autonomous commercial aircraft that makes short flights on demand to transport persons or things from one point to another.

AI: Artificial Intelligence (AI) is the use of computers, machines, algorithms, and software to mimic the problem-solving capabilities of the human mind. “AI” may also refer to the machines themselves. AI can be used to make tasks and processes more efficient and can solve problems/perform tasks in a matter of seconds that would otherwise take a computer or humans hours, days, or even years to solve/complete.

Firewall: A firewall is a network security device that monitors incoming and outgoing network traffic and decides whether to allow or block specific traffic based on a defined set of security rules. A firewall can be hardware, software, software-as-a-service, public cloud, or private cloud (virtual).

The following paragraphs provide an exemplary and non-exhaustive list of vehicle manufacturer mobile applications that are designed for use with their respective vehicles:

FordPass®: FordPass® is a mobile application created by Ford that allows users to communicate with their compatible Ford vehicles. This mobile application allows users to check the fuel levels, view vehicle health alerts, view service history, view warranty details, remote lock/unlock their vehicles, and remote start/stop their vehicles from their mobile devices.

HondaLink®: HondaLink® is a mobile application created by Honda that allows users to communicate with their compatible Honda vehicles. This mobile application allows users to access the owners' manuals of their vehicles, receive recall notifications regarding their vehicles, book service appointments for their vehicles, utilize 24/7 roadside assistance, view vehicle health reports, remote lock/unlock their vehicles, and remote/start/stop their vehicles from their mobile devices.

MyNissan®: MyNissan® is a mobile application created by Nissan that allows users to communicate with their compatible Nissan vehicles. This mobile application allows users to utilize roadside assistance, receive recall notifications regarding their vehicles, view service history, view the tire pressures, view the odometer, view warranty details, locate their vehicles, view vehicle health reports, access the owners' manuals of their vehicles, remote lock/unlock their vehicles, and remote/start/stop their vehicles from their mobile devices.

MyAudi®: MyAudi® is a mobile application created by Audi that allows users to communicate with their compatible Audi vehicles. This mobile application allows users to set geofence boundaries for their vehicles, check the fuel levels, turn on/off the lights of their vehicles, roll up/down the windows of their vehicles, locate their vehicles, remote lock/unlock their vehicles, and remote/start/stop their vehicles from their mobile devices.

My BMW®: My BMW® is a mobile application created by BMW that allows users to communicate with their compatible BMW vehicles. This mobile application allows users to make mobile payments on their vehicles' loans, view the odometer, locate their vehicles, check the fuel levels, receive maintenance alerts, book service appointments for their vehicles, remote lock/unlock their vehicles, and remote/start/stop their vehicles from their mobile devices.

MyChevrolet®: MyChevrolet® is a mobile application created by Chevrolet that allows users to communicate with their compatible Chevrolet vehicles. This mobile application allows users to check the fuel levels, view the tire pressures, set and save personalized climate preferences, remote lock/unlock their vehicles, and remote/start/stop their vehicles from their mobile devices.

Mercedes Me Connect®: Mercedes Me Connect® is a mobile application created by Mercedes that allows users to communicate with their compatible Mercedes vehicles. This mobile application allows users to check the fuel levels, view the tire pressures, locate their vehicles, remote lock/unlock their vehicles, and remote/start/stop their vehicles from their mobile devices.

Toyota App: Toyota App is a mobile application created by Toyota™ that allows users to communicate with their compatible Toyota vehicles. This mobile application allows users to make mobile payments on their vehicles' loans, receive recall notifications regarding their vehicles, locate their vehicles, remote lock/unlock their vehicles, and remote/start/stop their vehicles from their mobile devices.

Onstar®: Onstar® is a mobile application created by Onstar™, LLC, that provides roadside assistance, remote door unlock, theft detection, location assistance, and automatic notification of airbag deployment to users, along with electronic transmissions of voice messages and data.

The following paragraphs provide an exemplary and non-exhaustive list of other technologies and software components described in the present disclosure:

Electronic Toll Collection (ETC): Electronic Toll Collection technology is a wireless system that automatically collects tolls without requiring drivers to stop. ETC systems use a combination of technologies, such as radio transponders, automatic number plate recognition (ANPR), and global navigation satellite systems (GNSS) to identify vehicles and collect tolls. Drivers can use an ETC card in an in-vehicle device to pay tolls.

Global Navigation Satellite System (GNSS): A Global Navigation Satellite System is a network of satellites that broadcast timing and orbital information used for navigation and positioning measurements.

Toll Transponders: Toll Transponders are wireless transmitters that attach to a vehicle and send radio signals to toll collection technologies and devices. Toll Transponders connect tolling authorities to a user's payment information, allowing collectors to charge the user's account efficiently and provide the user with essential transactional data.

REST API: A REST API (also referred to as a RESTful API) is an application program interface (API) that conforms to the design principles of the representational state transfer (REST) architectural style. REST APIs provide a flexible, lightweight way to integrate applications and to connect components in various architectures.

SDK: A Software Development Kit (SDK) is a collection of tools that help software developers create applications for a specific program, operating system, or programming language. These tools, which include but are not limited to debuggers, compilers, libraries, frameworks, APIs, documentation, tutorials, and guides, are designed to make the process of building applications more efficient and effective. These tools can help developers create new applications that integrate with existing programs or applications as well.

### SUMMARY

This summary is provided to introduce a selection of concepts in a simplified form that are further described below in the detailed description. This summary is not intended to identify key features of essential features of the claimed subject matter, nor is it intended to be used to limit the scope of the claimed subject matter. Furthermore, the claimed subject matter is not limited to implementations that solve any or all disadvantages noted in any part of this disclosure.

A universal fare payment, fare collection, and smart device integration system, the system comprising one or more storage machines holding instructions executable by one or more logic machines to: via a user's electronic device, employ an interoperability application to communicate with access control applications/technologies to: schedule, book, plan, and apply applicable discounts to a trip leg by leg via a plurality of different transportation systems; detect a first ticketing technology of a first nearby transportation system for a first leg of the trip utilizing a first specific data type selected from NFC, QR code, Bluetooth technology, BLE technology, GPS, RFID, contactless card technology, facial recognition technology, or other biometric reading technologies, such as fingerprints, retinal scans, voice recognition, and handprint reading technology; configure the user's electronic device for authorizing payment of at least one of a ticket and pass via the first ticketing technology by formatting the user's electronic device to register and handle the first specific data type utilized by the first ticketing technology; at the user's electronic device, via the interoperability application, detect a second ticketing technology of a second nearby transportation system for a second leg of the trip utilizing a second specific data type selected from NFC, QR code, Bluetooth technology, BLE technology, GPS, RFID, contactless card technology, facial recognition technology, or other biometric reading technologies, such as fingerprints, retinal scans, voice recognition, and handprint reading technology, the second ticketing technology being different from the first ticketing technology and the second specific data type being the same as or different from the first specific data type; configure the user's electronic device for authorizing at least one of a ticket and pass via the second ticketing technology by formatting the user's electronic device to register and handle the second specific data type utilized by the second ticketing technology; and communicate with access control technologies to allow the user to communicate with and open access-controlled doors, gates, and other entryways and exits.

The universal fare payment, fare collection, and smart device integration system, wherein the instructions are executable to determine a mobile device protocol, the first and second ticketing technologies are one of NFC technology, contactless card reader technology, BLE technology, a Bluetooth technology, facial recognition technology, and other biometric reading technologies, such as fingerprints, retinal scans, voice recognition, and handprint reading technology, the nearby transportation system is determined via a GPS subsystem, wherein a mobile application takes a last known user location, compares it to a database of public transportation authorities (PTAs) and their associated technologies, determines the correct PTA, and sends information regarding the correct communication protocols for that PTA to the user's electronic device, the access control technologies are one of NFC technology, contactless card reader technology, BLE technology, and a Bluetooth technology, and the user's electronic payment platform is selected from the group including Venmo, Cash App, Zelle, WeChat Pay, Alipay, Samsung Pay, Apple Pay, Google Pay, digital currency, cryptocurrency, central bank digital currency, autopay, and Dwolla. The determination of the nearby transportation system is determined via a GPS subsystem is done utilizing artificial intelligence. The artificial intelligence uses predictive analysis models to analyze the GPS data being received from the user's device, and automatically connects with a nearby transportation system to connect the user's device with the fare collection.

The universal fare payment, fare collection, and smart device integration system, the system comprising one or more storage machines holding instructions executable by one or more logic machines to: via a user's electronic device, employ an interoperability application to communicate with electronic toll ticketing technologies to: pay the toll on a toll road, bridge, or tunnel; and via the user's electronic device, connect to the user's bank account or electronic payment platform account to cover the cost of a toll or fare.

The universal fare payment, fare collection, and smart device integration system, wherein instructions are executable to determine a mobile device protocol, the user's electronic payment platform is selected from the group including Venmo, Cash App, Zelle, WeChat Pay, Alipay, Samsung Pay, Apple Pay, Google Pay, digital currency, cryptocurrency, central bank digital currency, autopay, and Dwolla, and the device can connect to multiple different toll ticketing technologies in the same trip.

The universal fare payment, fare collection, and smart device integration system, wherein the nearby toll ticketing technology is determined via a GPS subsystem, wherein a mobile application takes a last known user location, compares it to a database of toll ticketing technologies, determines the correct toll ticketing technology, and sends information regarding the correct communication protocols for that toll ticketing technology to the user's electronic device, wherein the user's electronic device is configured to communicate with said toll ticketing technology via said communication protocol, and the toll ticketing technologies are one of NFC technology, contactless card reader technology, BLE technology, a Bluetooth technology, ETC technology, facial recognition technology, and other biometric reading technologies, such as fingerprints, retinal scans, voice recognition, and handprint reading technology. The determination of the nearby toll ticketing system is determined via a GPS subsystem is done utilizing artificial intelligence. The artificial intelligence uses predictive analysis models to analyze the GPS data being received from the user's device, and automatically connects with a nearby toll ticketing technology to connect the user's device with the toll collection.

The universal fare payment, fare collection, and smart device integration system, the system comprising one or more storage machines holding instructions executable by one or more logic machines to: via a user's electronic device, employ an interoperability application to communicate with smart home platforms and vehicle applications to: remotely connect to the user's smart home devices and appliances; remotely connect to the user's virtual assistants; remotely connect to the user's motorized vehicle's mobile application; and remotely connect to the user's garage door opener to allow the user to open and close their garage door(s) via this system on their electronic device; via a user's smart home devices and appliances, employ an interoperability application to communicate with smart home platforms and vehicle applications to: remotely connect to the user's other smart home devices and appliances; remotely connect to the user's virtual assistants; remotely connect to the user's motorized vehicle's mobile application; and remotely connect to the user's garage door opener to allow the user to open and close their garage door(s) via this system on their electronic device. The user's electronic device can utilize artificial intelligence to automatically connect with appliances, smart home platforms, and vehicle applications to the user's electronic device, and allow information to flow back and forth.

The universal fare payment, fare collection, and smart device integration system, wherein the instructions are executable to determine a mobile device protocol, the user's virtual assistant is selected from the group including Amazon Alexa, Google Home, Google Nest, and Apple Siri, the system remotely connects to the user's motorized vehicle's mobile application to access remote start capabilities and to check car health reports, the system can remotely connect to multiple different smart home platforms at the same time, the system can remotely connect to multiple different smart home devices and platforms at the same time, the system can remotely connect to multiple different virtual assistants at the same time, and the system can remotely connect to multiple different motorized vehicle mobile applications at the same time.

These and other objects, features, and advantages of the present teaching will become more readily apparent from the attached drawings and the detailed description of the aspects of the present teaching, which follow.

### BRIEF DESCRIPTION OF THE DRAWINGS

Aspects of the present teaching will hereinafter be described in conjunction with the appended drawings provided to illustrate and not to limit the present teaching, where like designations denote like elements, and in which:

FIG. 1 schematically presents an exemplary computing system in accordance with aspects of the present teaching;

FIG. 2 schematically presents a high-level overview of a universal fare payment and collection method in accordance with aspects of the present teaching;

FIG. 3A schematically presents a subprocess component flow method of the universal fare payment and collection method in accordance with aspects of the present teaching;

FIG. 3B schematically presents the remainder of the subprocess component flow method in FIG. 3A

FIG. 4 schematically presents a contactless reader subprocess method flow of the universal fare payment and collection method in accordance with aspects of the present teaching;

FIG. 5 schematically presents a back office overview for a customer engagement hub subsystem in accordance with aspects of the present teaching;

FIGS. 6 and 7 present an example user interface for planning a trip using a mobile app in accordance with aspects of the present teaching;

FIG. 8 schematically presents a sub-system for ticketing, payment, and customer engagement in accordance with aspects of the present teaching;

FIGS. 9A and 9B schematically present a sub-system for booking and billing tickets, in accordance with aspects of the present teaching;

FIG. 10 schematically presents a flow of NFC data from a terminal to a mobile application, in accordance with aspects of the present teaching;

FIG. 11 schematically presents a high-level flow to issue a secure element, in accordance with aspects of the present teaching;

FIG. 12 schematically presents a graphical representation of a mobile SDK configured to allow contactless reader communication with various systems, in accordance with aspects of the present teaching;

FIG. 13A schematically presents a high-level system view of a secure element and contactless reader framework in a mobile device, in accordance with aspects of the present teaching;

FIG. 13B schematically presents an NFC communication sub-system with a secure element, in accordance with aspects of the present teaching;

FIG. 13C schematically presents an NFC communication sub-system without a secure element, in accordance with aspects of the present disclosure;

FIG. 14 schematically presents an SE-based NFC card emulation subsystem, displaying how the TSM communicates with the SE chip and how the NFC chip communicates with a contactless reader device;

FIG. 15 schematically presents an OTA communication sub-system displaying how a TSM is used to provide credentials to an SE;

FIG. 16 graphically depicts the hardware contained within an HCE-enabled mobile device utilizing an SE;

FIG. 17 graphically depicts how an HCE subsystem obtains credentials from the cloud; and

FIG. 18 graphically depicts an Android HCE protocol stack.

Like reference numerals refer to like parts throughout the several views of the drawings.

### DETAILED DESCRIPTION

The following detailed description is merely exemplary in nature and is not intended to limit the described aspects or the application and uses of the described aspects. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the aspects of the present teaching and are not intended to limit the scope of the present teaching, which is defined by the claims. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary aspect of the present teaching defined in the appended claims. Hence, specific dimensions and other physical characteristics relating to the aspects disclosed herein are not to be considered as limiting, unless the claims expressly state otherwise. It is to be understood that each of the below methods may be executed in order as presented below, or in any appropriate order.

Disclosed is a universal fare payment and collection system. The system may comprise one or more storage machines holding instructions executable by one or more logic machines to carry out tasks and methods described herein. For example, the instructions may be executable by the system or sub-systems to carry out methods shown in the figures.

The herein disclosed universal fare payment and collection system may be referred to as PASSEKO. This PASSEKO collection system may include a mobile app (the PASSEKO App) available on any mobile platform, including but not limited to the iPhone Appstore, the android app store, and google play. The mobile app may be integrated with virtual assistant technologies, including but not limited to Amazon Alexa, Google Nest, and Apple Siri.

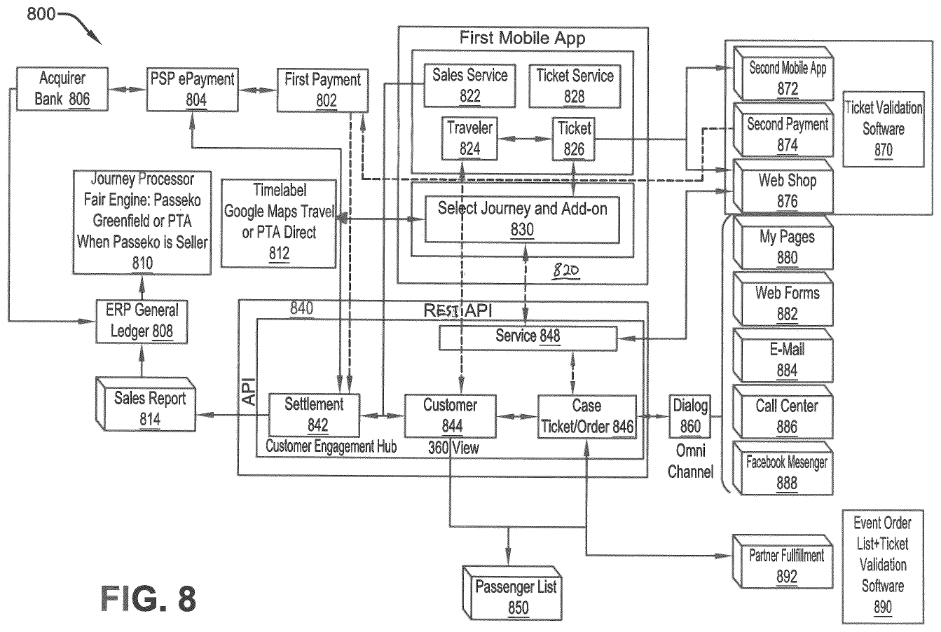

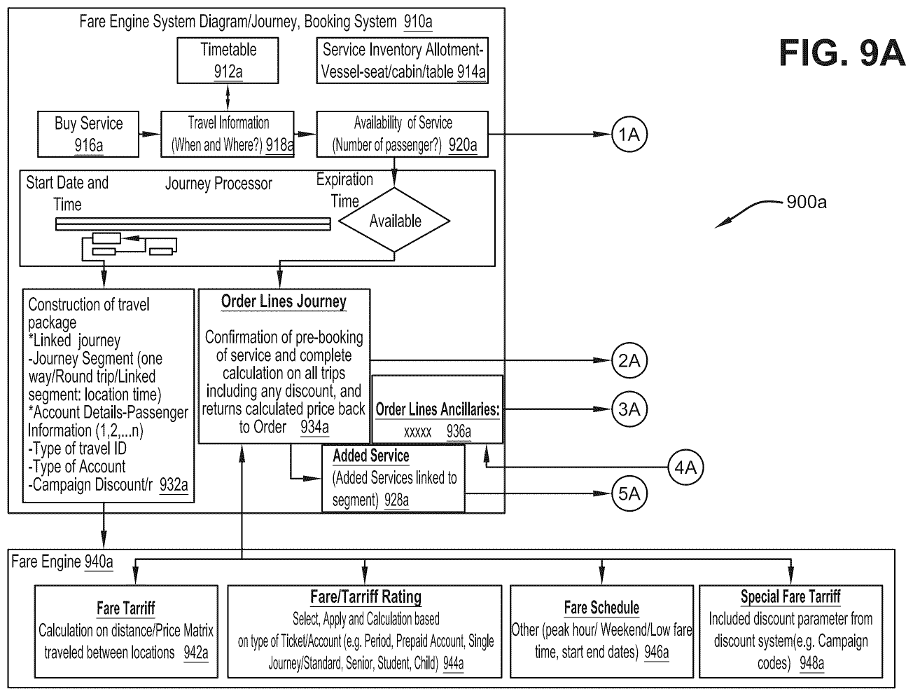

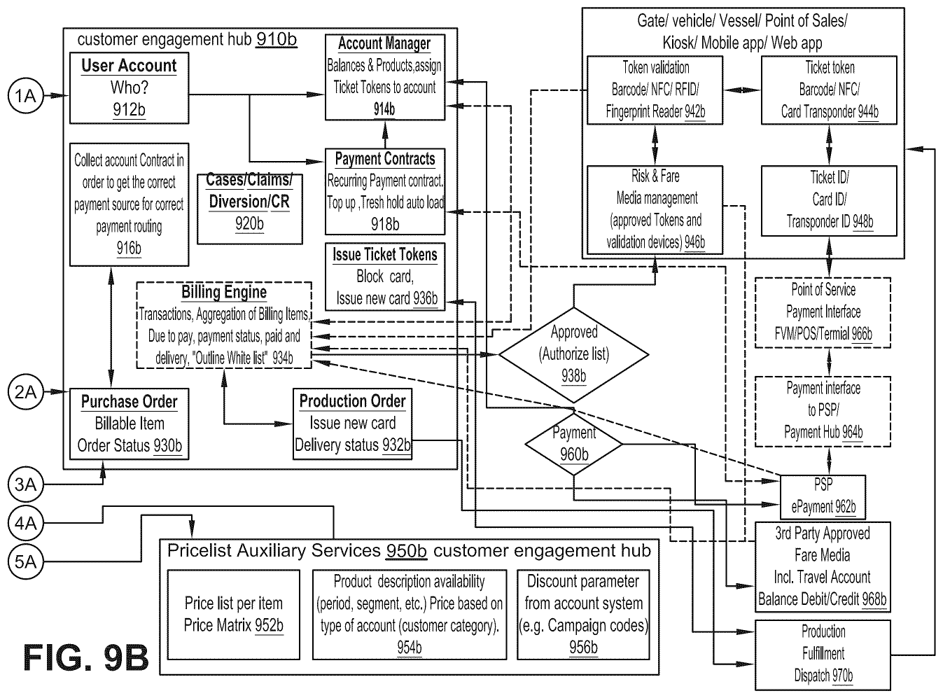

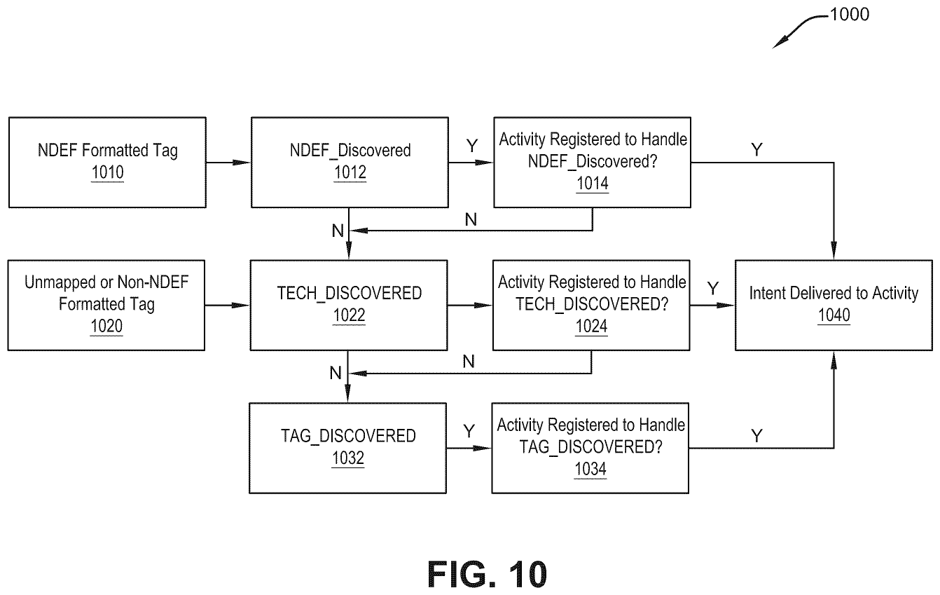

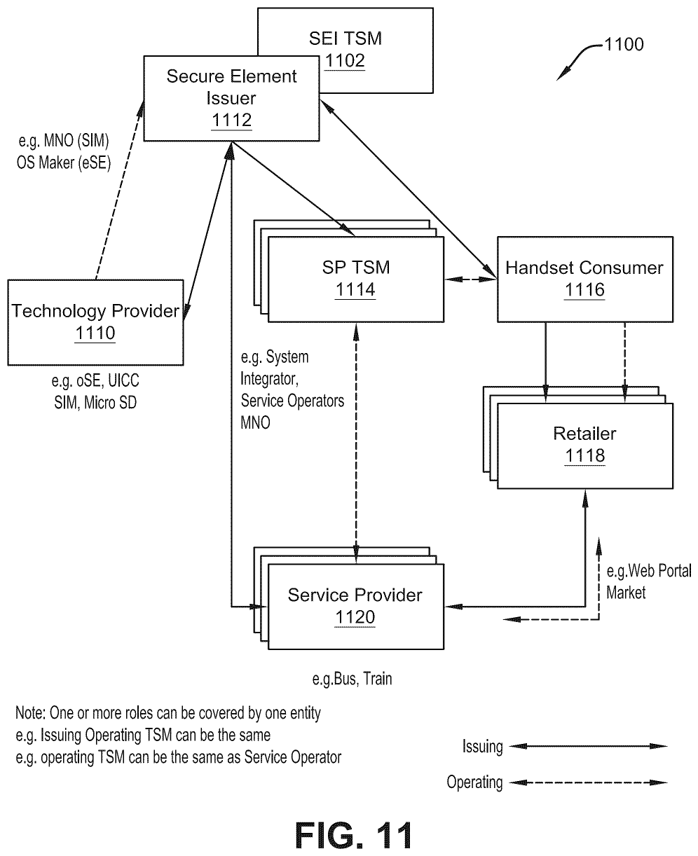

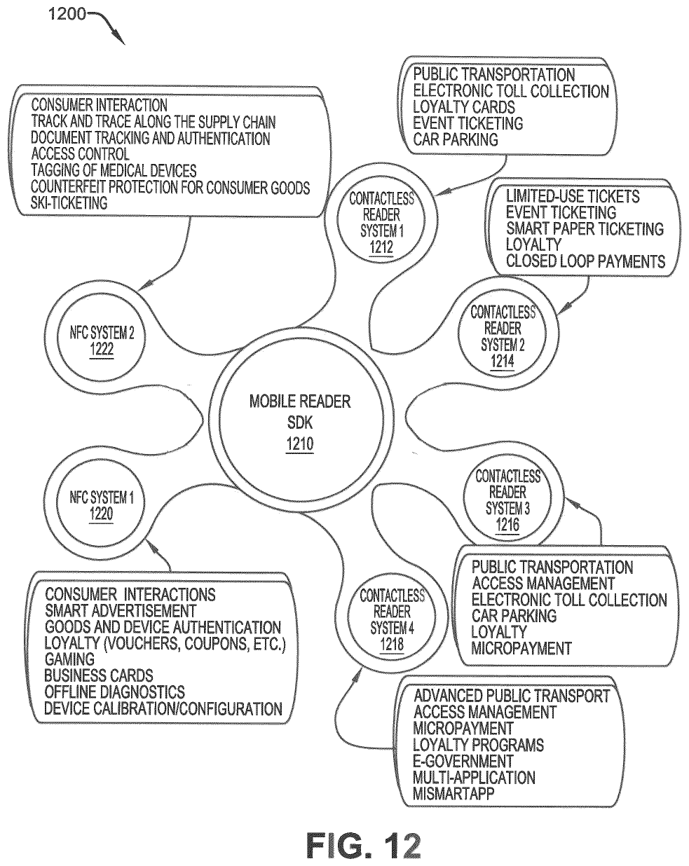

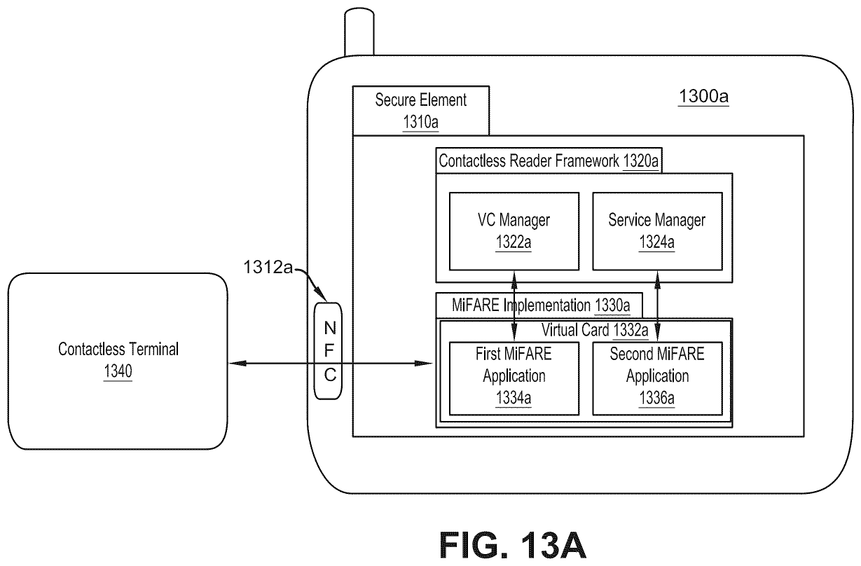

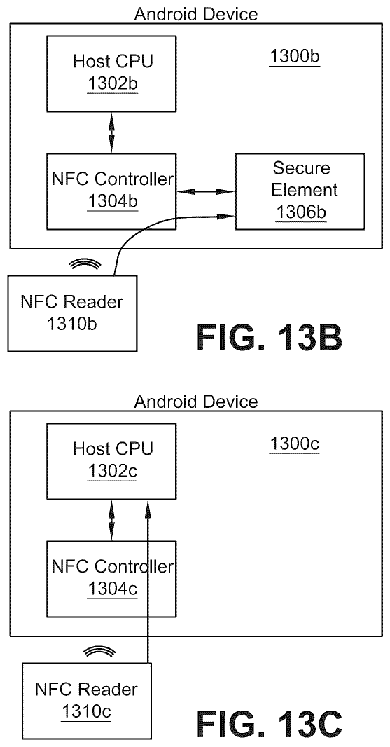

The system may include any appropriate sub-system or sub-method to carry out the tasks. For example, FIG. 8 schematically presents a sub-system for ticketing, payment and customer engagement, FIGS. 9A and 9B schematically present a sub-system for booking and billing tickets, FIG. 10 schematically presents a flow of NFC data from a terminal to a mobile application, FIG. 11 schematically presents a high level flow to issue a secure element, FIG. 12 schematically presents a mobile SDK configured to allow contactless reader technology communication with various systems, FIG. 13A schematically presents a high level system view of a secure element and a contactless reader technology framework in a mobile device, FIG. 13B schematically presents an NFC communication sub-system with a secure element, and FIG. 13C schematically presents an NFC communication sub-system without a secure element.

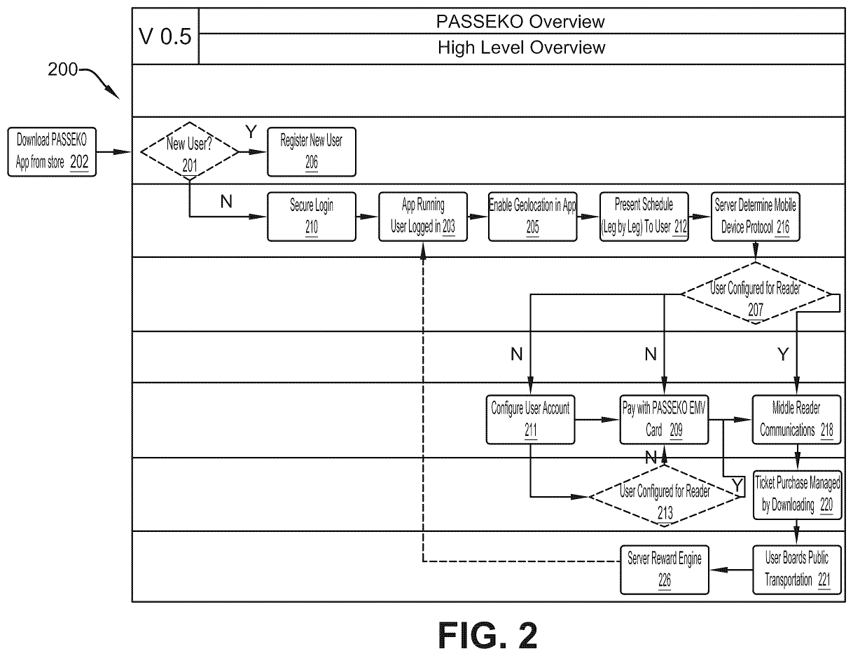

Turning to FIG. 2, method 200 may include at 202 providing a mobile application (app) on Google Play or Apple App Store for a user to download and downloading the mobile application onto a mobile phone, at 206 registering to use the mobile application from inside the app and creating a username, password, and/or access credentials for using the application, at 216 receiving, identifying or determining a payment method for purchasing global transportation tickets or passes (e.g. ACH, credit card number, Apple Pay, Android Pay, Samsung pay), at 210 logging-in a user to the mobile application for viewing nearest public transportation services using GPS, at 212 accessing and/or displaying a schedule and/or hours of operation for a transportation service (train, subway, or bus), and/or displaying a price of a ticket for a selected schedule item, and at 220 purchasing a ticket with the mobile application from the schedule.

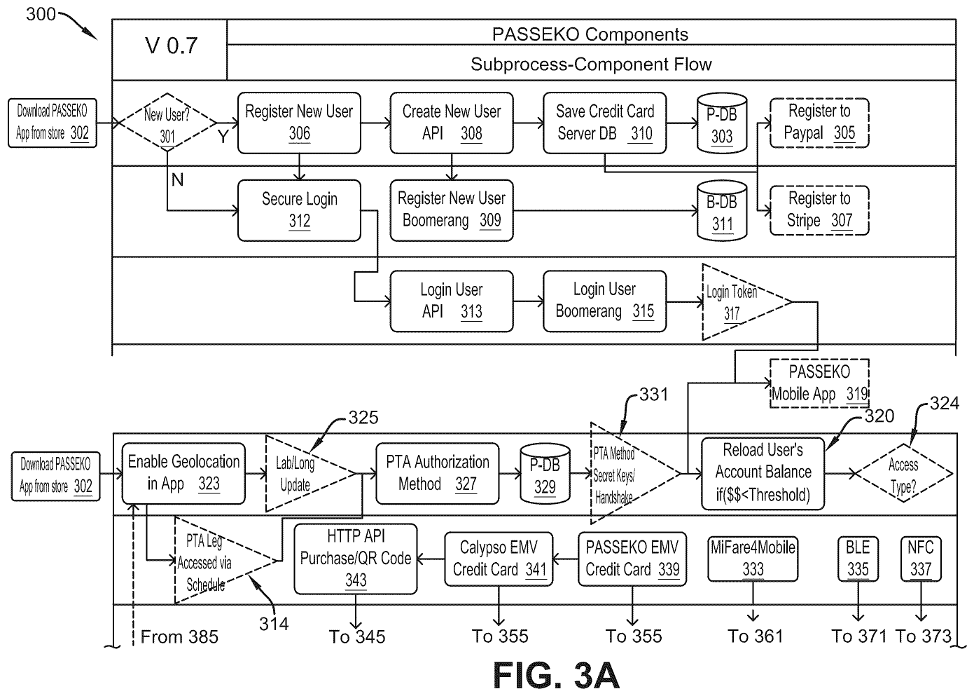

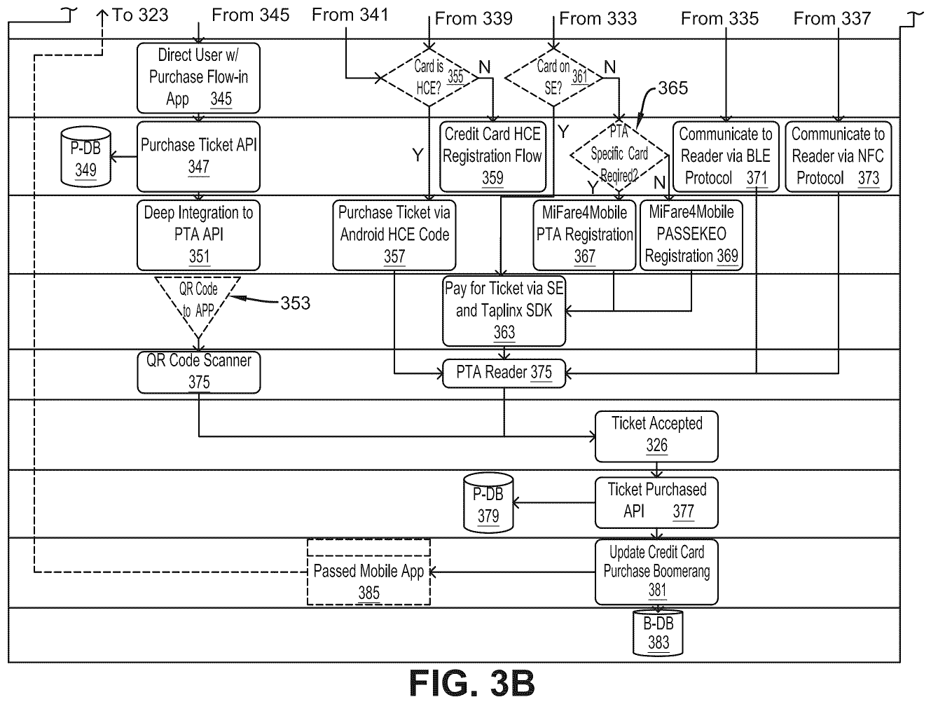

Turning to FIGS. 3A and B, at 320 method 300 may include indicating one method of payment.

Turning back to FIG. 2, method 200 may include at 220 upon entering a public transportation service (e.g. a user may enter), presenting or displaying ticket presentment (validation) options available at a specific or selected location, at 218 in response to a tap and go function of the mobile app or mobile phone, reading a purchased ticket for allowing a user to board selected public transportation (e.g. by activating a contactless reader), and at 224 confirming that the ticket was accepted.

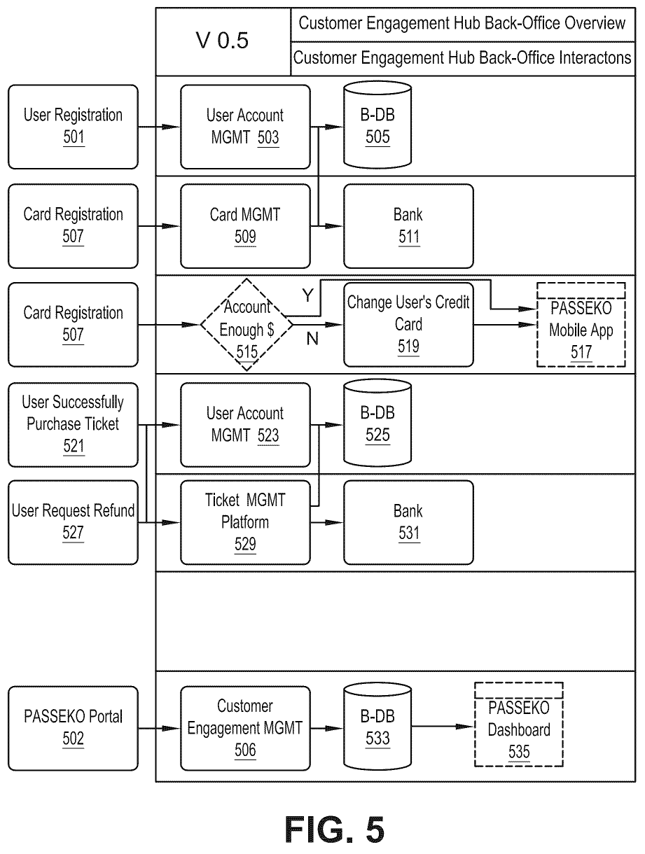

Turning to FIG. 5, method 500 may include at 506 providing, displaying, presenting, or viewing a history of ticket purchases made via the mobile application, further at 506 providing, displaying, presenting, or viewing an amount of funds withdrawn from the user's payment account, further at 506 providing, displaying, presenting, or viewing unused and/or available tickets associated with a user's account, and further at 506 providing, displaying, presenting, or viewing special offers and rewards associated with the use of the mobile application for fare payment.

Turning back to FIG. 2, method 200 may include at 226 providing validation of distance traveled by using a check-out process available within some public transport services.

Turning back to FIG. 5, method 500 may further include at 506 contacting customer service through the mobile app in response to a user input.

Further details of FIG. 2 will now be described. At 201, the system may first determine if a user is a new user. At 206, if the user is a new user, the mobile application prompts a user to register a new account. At 210, if the user is not a new user, the user may log in securely. At 203 a user is logged in while the app is running. At 205 geolocation is enabled in the app. At 212 a schedule is presented to a user (e.g., leg by leg). At 216, a server determines a mobile-device protocol. At 207, a user is configured for an appropriate reader. At 209, the method includes paying with an EMV card, at 211 a user account is configured, and at 218 a mobile reader communication is initialized or executed. At 213 a user may be configured for a reader before paying via EMV at 209. At 220, a ticket purchase API is managed by a customer engagement hub as described in more detail below. At 224, the user boards public transportation according to a purchased ticket. At 226, a server-reward engine is initialized or executed.

Further details of FIGS. 3A and B will now be described. At 301 the method determines if a user is a new user, at 306 a new user is registered, and if the user is already registered, at 312 the user is logged in securely. Subsequent to registering a new user, at 308 a new user API is created, at 310 a credit card is saved in a first database (DB1) at 303. Additionally, or alternatively, after credit card info is saved, the method may continue to register the user account and/or credit card to PayPal at 305 or stripe at 307. Further, after creating a new user API at 308, the method may continue to register a new user using a customer engagement hub at 309, and storing the registration in a second database (DB2) at 311. The second database DB2 may be part of the customer engagement hub system. Turning back to logging in a user at 312, after a user is logged in a login API may be created and/or executed and/or displayed at 313, and at 315 a user may be logged into a customer engagement hub. At 317, a login token is generated, and the login token may be passed to, or used to log in to, a front-end of the mobile app at 319.

Even further details of FIGS. 3A and B will now be described. At 321, the app is running, and a user is logged in. At 323 geolocation is enabled in the app and at 325 latitude/longitude updates are executed. At 314, a PTA leg is accessed via a schedule. At 327 a PTA Authorization method is determined. At 329, DB2 receives one or more of the preceding information in the flow, and at 331 a PTA method and secret keys and/or handshake are determined and/or registered. Information processed at 331 may then be relayed to the front-end of the mobile app at 319. At 320, the method may continue from 331 to reload a user's account balance (e.g., if an amount of money in the user's account is less than a predetermined threshold value). At 324 an access type is determined. For example, at 333 the access type is a contactless reader, at 335 the access type is a BLE system, and at 337 the access type is an NFC system. Further, at 339 the access type is an EMV credit card, and at 341 an electronic ticketing standard microprocessor for contactless smart cards. At 343, an HTTP API Purchase or QR code is generated and used to direct a user at 345 to a purchase ticket API. The purchase ticket API information may be processed at 347 and sent to DB1 at 349. At 351, deep integration to a PTA API is executed, and at 353 a QR code is sent to the mobile application. At 322 a QR code scanner scans the QR code and at 326 a ticket is accepted.

Turning back, at 355 in FIGS. 3A and B the system determines if a card is configured for host card emulation (HCE). If the card is determined to be HCE configured, then at 357 a ticket is purchased via an android HCE code. If the card is determined as not being HCE, at 359 a credit card HCE registration flow is executed. Turning back, at 361 it is determined if a card is on a secure element, and at 363 a ticket is paid for via a secure element and a contactless reader

SDK. For example, a secure element may be a secure microcontroller capable of securely hosting applications and their confidential and/or cryptographic data (e.g., key management). If the card is determined as not being on a secure element, at 365 it is determined if a PTA specific card is required. If a PTA specific card is required, at 367 a contactless card reader registration is made specifically for the specific PTA. At 369, a general contactless card reader registration is made for the disclosed system. Turning back, at 371 data is communicated to a reader via BLE protocol, and at 373 data is communicated to a reader via NFC protocol. Data processed at steps 357, 371, and/or 373 may be relayed to a PTA reader at 375. At 326 a ticket is accepted and then at 377 a ticket is purchased through an API and appropriate information is passed to DB1 at 379. At 381 a credit card purchase is updated through a customer engagement hub and subsequently appropriate information is sent to DB2 at 383 and a front-end of the mobile app at 385.

It is to be understood that a Secure Element (SE) may be a tamper-resistant platform capable of securely hosting applications and their confidential and cryptographic data in accordance with the rules and security requirements set forth by a set of well-identified trusted authorities. Put simply, a Secure Element can be considered a chip that offers a dynamic environment to store data securely, process data securely and perform communication with external entities securely. A SE may self-destruct upon being tampered with, and/or be configured to block unauthorized access.

To provide security to NFC applications that involve financial transactions, the Secure Element may reside in highly secure crypto chips. The secure element may provide delimited memory for each application stored in it and other functions that can encrypt, decrypt and sign the data packet.

In smartphones, a Secure Element may be located as a chip embedded directly into a phone's hardware, or in a SIM/UICC card provided by a network operator or in an SD card that can be inserted into mobile phone.

Using an NFC enabled mobile device to “tap and pay”, an NFC controller of the device may change into card-emulation mode. In one example, the NFC controller itself may not deal with data or processing associated with a payment transaction. The NFC controller may be an interface that allows communication using standard protocols.

The Secure Element emulates a contactless card. The secure element may perform a handshake with a terminal, send correct responses to correct or appropriate queries, generates dynamic cryptograms, and authenticates a stored card. In some examples, the Secure Element may not emulate the contactless card. Software that emulates a contactless card may be one that is stored inside the secure element in the form of payment applications or applets. The Secure Element provides secure storage and execution environment for the payment applications to do their job.

It is to be understood that a Secure Element may or may not be included in the disclosed system. Host-based Card Emulation (HCE) may be implemented to move a secure storage and execution environment to a cloud instead of the Secure Element.

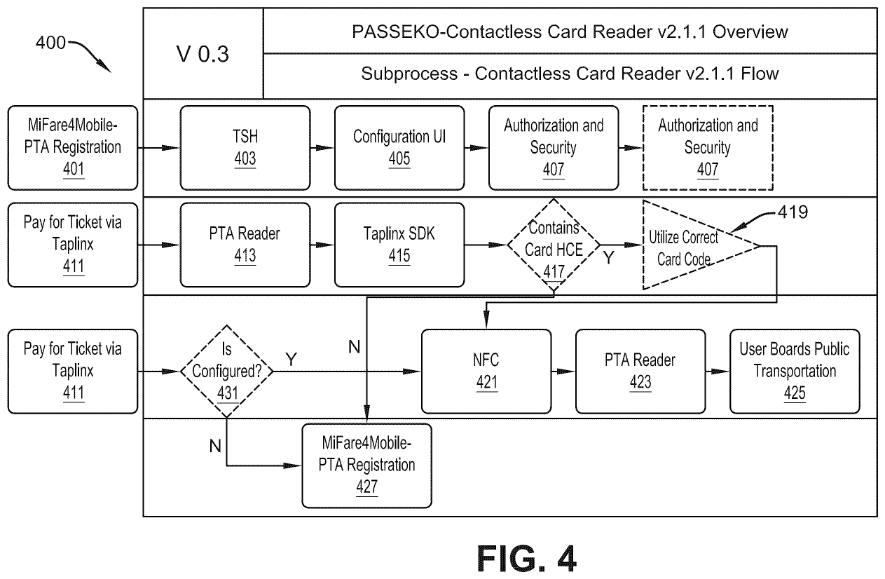

As shown in FIG. 4, a contactless card reader registration is made at 401, at 403 a trusted service hub (TSH) receives and processes the data from the registration and sends the data to a configuration UI at 405. At 407 an authorization and security step is executed before sending processed data to a front-end of the mobile app at 409. At 411 a ticket is paid for via a contactless reader, and the data is received by a PTA reader at 413. At 415, a contactless reader SDK receives data and at 417 it is determined if HCE data is present. At 419, correct card code is utilized and at 421 an NFC sub-system receives data from step 419 that is then sent to a PTA reader at 423 so that at 425 a user boards public transportation. If HCE data is not found, the method continues to register contactless reader information for a PTA at 427. Further, at 429, a ticket is paid for via a secure element. At 431 a correct configuration is determined before sending data to an NFC subsystem at 421. If a configuration is not determined as being correct, the method continues to a registration step at 427.

Further details of FIG. 5 will now be described. At 501 a user registration is received, and at 503 user account management is executed, and at 505 DB2 receives information from step 503 of the user account management. At 507, a card registration is received, at 509 the card registration is managed, and at 511 a bank receives information regarding the managed card. At 513, the mobile app requests a new PTA terminal with a location. At 515, it is determined if an account has enough money. At 517, information from step 515 is passed to a front-end of the mobile app, or if funds are insufficient at 519 a user's credit card is charged. At 521, a user successfully purchases a ticket, at 523 user account management is executed, and at 525 DB2 receives information regarding the user account management. At 527 a user requests a refund and at 529 a ticket management platform receives refund information. At 531 a bank receives information from the ticket management platform. At 502 a web portal is executed or displayed, at 506 customer engagement management is executed, at 533 DB2 receives information regarding the customer engagement management, and at 535 a front-end dashboard of the mobile application receives customer engagement management information from DB2.

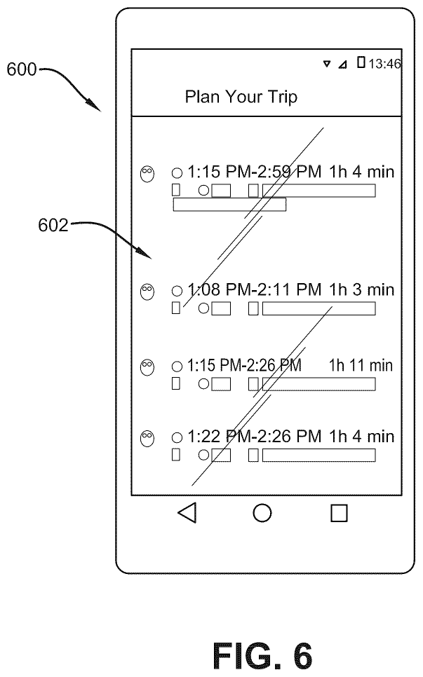

The illustration of FIGS. 6 shows a mobile device 600 displaying an example user interface 602 for planning a trip using the mobile app disclosed herein. For example, the interface 602 may be used to schedule and plan trips via a plurality of different transport authorities and systems using a single interface or device.

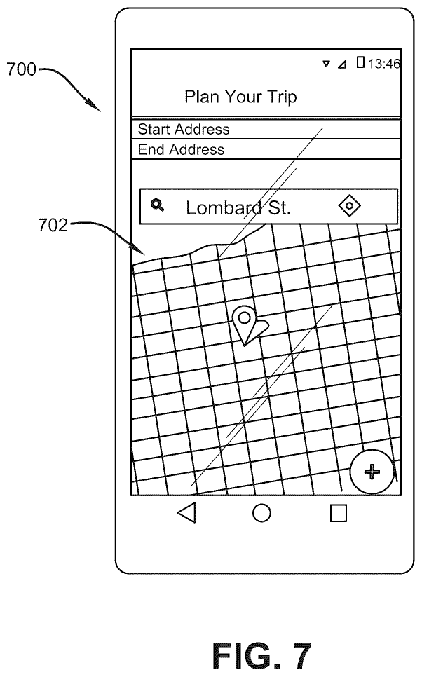

The illustration of FIG. 7 shows a mobile device 700 displaying an example user interface 702 for planning a trip using the mobile app disclosed herein. For example, the interface 702 may be used to graphically display routes for trips scheduled and planned via a plurality of different transport authorities and systems using a single interface or device.

FIG. 8 schematically presents a sub-system 800 for ticketing, payment, and customer engagement. This subsystem 800 includes a first Payment function 802, a PSP ePayment function 804, an Acquirer Bank 806, an ERP General Ledger 808, a Journey Processor Fair Engine 810, a Time Label Google Maps or PTA Direct database 812, a Sales Report 814, a First Mobile App 820, a Customer Engagement Hub 840, a Passenger List 850, an Omni-Channel Dialog protocol 860, a Ticket Validation Software 870, a MyPages function 880, a Web Forms function 882, an E-Mail function 884, a Call Center function 886, a Facebook Messenger function 888, an Event Order List +Ticket Validation Software 890, and a Partner Fulfillment function 892. The First Mobile App 820 includes a Sales Service function 822, a Traveler function 824, a Ticket function 826, a Ticket Service function 828, and a Select Journey and Add-On function 830. The Customer Engagement Hub 840 contains a Settlement function 842, a Customer function 844, a Case Ticket/Order function 846, and a Service function 848. The Ticket Validation Software 870 contains a Second Mobile App 872, a second Payment function 874 and a Web Shop function 876.

Further details of FIG. 8 will now be described. The First Mobile App 820 is a mobile application for use by consumers for the purposes of purchasing and managing tickets and fares for a plurality of different transportation authorities and systems. The Customer Engagement Hub 840 serves to facilitate and streamline interactions between this system and customers. The Customer Engagement Hub 840 may be a REST API. The Ticket Validation Software 870 is an application for use by PTAs for processing and validating tickets held by consumers.

Further details of FIG. 8 will now be described. The Ticket function 826 and the Traveler function 824 share information with one another. The first Payment function 802 and the PSP ePayment function 804 share information with one another during the payment process. The PSP ePayment function 804 and the Acquirer Bank 806 share information with one another during the payment process. Information from the Acquirer Bank 806 is logged in the ERP General Ledger 808 when the payment process is complete. Information from the ERP General Ledger 808 is then sent to the Journey Processor Fair Engine 810 for processing. The Select Journey and Add-On function 830 pulls information from and shares information with a Time label Google Maps or PTA Direct database 812. The Traveler function 824 and the Customer function 844 share information with one another. The Ticket function 826 and the Select Journey and Add-On function 830 share information with one another. The Select Journey and Add-On function 830 and the Service function 848 share information with one another. The Case Ticket/Order function 846 and the Service function 848 share information with one another. The Service function 848 sends information to the Web Shop function 876 for processing. The Customer function 844 and the Case Ticket/Order function 846 share information with one another. Information from the Customer function 844 and the Case Ticket/Order function 846 is added to the Passenger list 850. Information from the Sales Service function 822 is sent to the Customer function 844 for processing. Information from the Traveler function 824 and the Customer function 844 is shared with the Settlement function 842 during the settlement process. Information from the Settlement function 842 is sent to the Sales Report 814 for processing. After processing, information from the Sales Report 814 is then logged in the ERP General Ledger 808. Information from the second Payment function is sent to the first Payment function 802 for processing. Information from the first Payment function 802 is also sent to the Settlement function 842 when needed for settlement purposes. Communication between the PSP ePayment function 804 and the Settlement function 842 occurs during the settlement process as well. Communication between the Case Ticket/Order function 846 and the MyPages function 880, the Web Forms function 882, the E-Mail function 884, the Call Center function 886, and the Facebook Messenger function 888 occurs using the Omni-Channel Dialog protocol 860. Information from the Ticket function 826 is sent to the Second Mobile App 872 and the Web Shop function 876 for processing. Information from the Case Ticket/Order function 846 is sent to the Partner Fulfillment component 892 for processing.

FIG. 9A schematically presents a sub-system for booking and billing tickets. A Fare Engine System 900a includes a Journey, Booking and Billing System 910a and a Fare Engine 940a. The Journey, Booking and Billing System 910a contains a Time Table 912a, a Service Inventory Allotment 914a, a Buy Service function 916a, a Travel Information function 918a, an Availability of Service function 920a, a Journey Processor 930a, a Construction of Travel Package 932a, an Order Lines Journey function 934a, an Order Lines Ancillaries function 936a, and an Added Service function 938a. The Fare Engine 940a contains a Fare Tariff function 942a, a Fare Tariff/Rating function 944a, a Fare Schedule 946a, and a Special Fare Tariff function 948a.

Further details of FIG. 9A will now be described. The Journey Processor 930a serves to determine the start date, the start time, and the expiration time for journeys, as well as the availability of a given service or services. The Construction of Travel Package 932a determines the details of the journey, such as whether the trip is a one-way journey versus a round trip, and also determines the type of travel ID, the type of account, and whether there are any discounts available to the traveler. The Order Lines Journey function 934a serves to confirm the pre-booking of service(s), complete the calculation(s) on all trips including any discount, and to return calculated prices back to order. The Fare Tariff function 942a serves to calculate the distance(s) travelled between locations and the price(s) thereof. The Fare Tariff/Rating function 944a serves to select, apply, and calculate rates based on the type of ticket/account (e.g. period, prepaid account, single journey, standard, senior, student, child). The Fare Schedule 946a serves to determine the fare rate based on the timing of the journey (e.g. peak hours, weekend rates, low fare time, start and end dates). The Special Fare Tariff function 948a serves to find and include any discount parameters from the account system (e.g. campaign codes).

Further details of FIG. 9A will now be described. The Time Table 912a and the Service Inventory Allotment 914a share information with one another. The Time Table 912a and the Travel Information function 918a share information with one another. Information from the Buy Service function 916a is sent to the Travel Information function 918a for processing. The Service Information function 914a and the Availability of Service function 920a share information with one another. Information from the Travel Information function 918a is sent to the Availability of Service function 920a for processing. Information from the Travel Information function 918a is sent to the Journey Processor 930a to determine the start date, start time, and expiration time of the journey. Once the start date, start time, and expiration time of the journey are determined, the information is then sent from the Journey Processor 930a to the Construction of Travel Package 932a to determine the details of the journey. Once the details of the journey are determined, the information is sent from the Construction of Travel Package 932a to the Fare Engine 940a to calculate rates. Information from the Availability of Service function 920a is sent to the Journey Processor 930a to check the availability of a given services or services. If the service or services are available, the information is sent from the Journey Processor 930a to the Order Lines Journey function 934a for confirmation. The Order Lines

Journey function 934a, the Fare Tariff function 942a, the Fate Tariff/Rating function 944a, the Fare Schedule 946a, and the Special Fare Tariff function 948a all share information with each other when needed. Information from the Order Lines Journey function 934a is sent to the Added Services function 938a when needed.

FIG. 9B schematically presents a sub-system 900b for booking and billing tickets. A Customer Engagement Hub 910b includes a User Account function 912b, an Account Manager 914b, a Collect Account function 916b, Payment Contracts function 918b, a Cases/Claims/Diversion/ CR component 920b, a Billing Engine 934b, an Issue Ticket Tokens function 936b, a Purchase Order component 930b, and a Production Order component 932b. Further presented in FIG. 9B are a Gate/Vehicle/Vessel/Point of Sales/Kiosk/Mobile App/Web App 940b includes a Token Validation Barcode/NFC/RFID/Finger Print Reader 942b, a Ticket Token Barcode/NFC/Card Transponder 944b, a Risk & Fare Media Management component 946b, and a Ticket ID/Card ID/Transponder ID component 948b. FIG. 9B also presents a Price List Ancillary Services component 950b, including a Price List Per Item Matrix 952b, a Product Description Availability component 954b, and a Discount Parameter From Account System 956b. This sub-system also includes an Approved Authorized List 938b, a Payment function 960b, a PSP ePayment component 962b, a Payment Interface to PSP/Payment Hub 964b, a Point of Service Payment Interface FVM/POS/Terminal 966b, a 3^{rd} Party Approved Fare Media component 968b, and a Production Fulfillment Dispatch component 970b.

Further details of FIG. 9B will now be described. The Account Manager 914b serves to assign ticket tokens to an account. The Collect Account function 916b serves to collect an account contract in order to get the correct payment source for correct payment routing. The Payment Contracts function 918b facilitates recurring payment contracts, top-ups, and threshold auto-loads. The Billing Engine 934b handles transactions, the aggregation of billing items, payment status of various things within this subsystem. The Issue Ticket Tokens function 936b serves to block cards and issue new cards when needed. The Risk & Fare Media Management component 946b serves to approve tokens and validate devices.

Further details of FIG. 9B will now be described. The User Account function 912b sends user information to the Account Manager 914b, the Payment Contracts function 918b, and the Collect Account function 916b for processing. The Collect Account function 916b and the Purchase Order component 930b share information with one another. Information from the Payment Contracts function 918b to the Account Manager 914b as needed. Information from the Purchase Order component 930b is sent to the Payment function 960b for processing. Information from the Payment function 960b is sent to the Account Manager 914b, the PSP ePayment component 962b, and the 3^{rd} Party Approved Fare Media component 968b for processing. Information from the PSP ePayment component 962b and the 3^{rd} Party Approved Fare Media component 968b is sent to the Billing Engine 934b for transaction handling. The Account Manager 914b and the Billing Engine 934b share information with each other. The Production Order component 932b and the Billing Engine 934b share information with each other. Information from the Token Validation Barcode/NFC/RFID/Finger Print Reader 942b is sent to the Billing Engine 934b for processing. Information from the Billing Engine 934b is sent to the Approved Authorized List 938b and then to the Risk & Fare Media Management component 946b. The Payment Contracts function 918b and the PSP ePayment component 962b share information with one another. The Token Validation Barcode/NFC/RFID/Finger Print Reader 942b and the Ticket Token Barcode/NFC/Card Transponder 944b share information with one another. The Token Validation Barcode/NFC/RFID/Finger Print Reader 942b and the Risk & Fare Media Management component 946b share information with one another. Information from the Ticket ID/Card ID/Transponder ID component 948b is sent to the Ticket Token Barcode/NFC/Card Transponder 944b for identifying a Ticket/Card/Transponder. The Ticket ID/Card ID/Transponder ID component 948b and the Point of Service Payment Interface FVM/POS/Terminal 966b share information with one another. The Point of Service Payment Interface FVM/POS/Terminal 966b and the Payment Interface to PSP/Payment Hub 964b share information with one another. The Payment Interface to PSP/Payment Hub 964b and the PSP ePayment component 962b share information with one another. Information from the

Production Fulfillment Dispatch 970b is sent to the Gate/Vehicle/Vessel/Point of Sales/Kiosk/Mobile App/Web App 940b for processing. The Issue Ticket Tokens function 936b and the Production Fulfillment Dispatch 970b share information with one another. Information from the Production Order component 932b is sent to the Production Fulfillment Dispatch 970b for processing. The Risk & Fare Media Management component 946b and the 3^{rd} Party Approved Fare Media component 968b share information with one another.

Further details of FIG. 9A and FIG. 9B will now be described. Information from the Availability of Service function 920a is sent to the User Account function 912b for processing. Information from the Order Lines Journey function 934a and the Order Lines Ancillaries function 936a is sent to the Purchase Order component 930b for processing. Information from the Price List Ancillary Services component 950b is sent to the Order Lines Ancillaries function 936a for processing. Information regarding added services from the Added Service function 938a is sent to the Price List Ancillary Services component 950b for processing.

FIG. 10 schematically presents a flowchart 1000 showcasing the flow of NFC data from terminal to an Android App. This subsystem 1000 includes an NDEF Formatted Tag 1010, an NDEF_Discovered step 1012, an Activity Registered To Handle NDEF_Discovered step 1014, an Unmapped or Non-NDEF Formatted Tag 1020, a TECH_Discovered step 1022, an Activity Registered To Handle TECH_Discovered step 1024, a TAG_Discovered step 1032, an Activity Registered To Handle TAG_Discovered step 1034, and an Intent Delivered To Activity step 1040.

Further details of FIG. 10 will now be described. The NDEF Formatted Tag 1010 is a tag that has been formatted to contain NDEF data. The NDEF_Discovered step 1012 determines whether the block of code processing the NDEF Formatted Tag contains a line containing the intent to start an activity when a tag with an NDEF payload is discovered. If so, the flow continues to the Activity Registered To Handle NDEF_Discovered step 1014, if not, the flow continues to the TECH_Discovered step 1022. The Activity Registered To Handle NDEF_Discovered step 1014 determines whether the line of code contains the necessary code to register and handle the tag with the NDEF payload discovered in the NDEF_Discovered step 1012. If so, the flow continues to the Intent Delivered To Activity step 1040, if not, the flow continues to the TECH_Discovered step 1022. The Unmapped or Non-NDEF Formatted Tag 1020 is a tag that has either been formatted to contain non-NDEF data or a tag that has not been formatted to contain any specific data type. The TECH_Discovered step 1022 determines whether the block of code processing the Unmapped or Non-NDEF Formatted Tag contains a line containing the intent to start an activity when a tag is discovered and activities are registered for the specific technologies on the tag. If so, the flow continues to the Activity Registered To Handle TECH_Discovered step 1024, if not, the flow continues to the TAG_Discovered step 1032. The Activity Registered To Handle TECH_Discovered step 1024 determines whether the line of code contains the necessary code to register and handle the tag registered for a specific technology discovered in the TECH_Discovered step 1022. If so, the flow continues to the Intent Delivered To Activity step 1040, if not, the flow continues to the TAG_Discovered step 1032. The TAG_Discovered step 1032 determines whether the block of code processing the tag contains a line containing the intent to start an activity when a tag is discovered. If so, the flow continues to the Activity Registered To Handle TAG_Discovered step 1034, if not, the process terminates. The Activity Registered To Handle TAG_Discovered step 1034 determines whether the line of code contains the necessary code to register and handle the tag discovered in the TAG_Discovered step 1032, if so, the flow continues to the Intent Delivered To Activity step 1040, if not, the process terminates. The Intent Delivered To Activity step 1040 is where the tag is transmitted from the terminal to the Android App.

FIG. 11 schematically presents a subsystem 1100 for issuing a secure element. This subsystem 1100 includes an SEI TSM component 1102, a Technology Provider 1110, a Secure Element Issuer 1112, an SP TSM component 1114, a Handset Consumer 1116, a Retailer 1118, and a Service Provider 1120.

FIG. 12 schematically presents a MiFARE4Mobile Communication subsystem 1200. This subsystem 1200 includes Mobile Reader SDK component 1210, which includes a Contactless Reader System #1 1212, a Contactless Reader System #2 1214, a Contactless Reader System #3 1216, a Contactless Reader System #4 1218, an NFC System #1 1220, and an NFC System #2 1222. In one aspect, the Mobile Reader SDK component 1210 is a TapLinx SDK. In one aspect, the Contactless Reader System #1 1212 is a MiFARE Ultralight System. In one aspect, the Contactless Reader System #2 1214 is a MiFARE Classic system and has increased security compared to the Contactless Reader System #1 1212. In one aspect, the Contactless Reader System #3 1216 is a MiFARE Plus system and has increased security compared to the Contactless Reader System #2 1214. In one aspect, the Contactless Reader System #4 1218 is a MiFARE DESFire system and has increased security compared to the Contactless Reader System #3 1216. In one aspect, the NFC System #1 1220 is an NTAG system. In one aspect, the NFC System #2 1222 is an ICODE system and has increased security compared to the NFC System #1 1220.

FIG. 13A schematically presents a subsystem 1300a showcasing a high-level view of the Secure Element and Contactless Reader frameworks within a mobile device. This subsystem 1300a includes a Secure Element component 1310a and NFC component 1312a. The Secure Element component 1310a includes a Contactless Reader Framework 1320a and a MiFARE Implementation function 1330a. The Contactless Reader Framework 1320a includes a VC Manager component 1322a and a Service Manager component 1324a. The MiFARE Implementation function 1330a includes a Virtual Card 1332a, which includes a First MiFARE Application 1334a and a Second MiFARE Application 1336a. FIG. 13A also schematically presents a Contactless Terminal 1340a.

FIG. 13B schematically presents a subsystem 1300b comprising an Android device utilizing NFC communication with a physical Secure Element card. This subsystem 1300b includes a Host CPU 1302b, an NFC controller 1304b, and a Secure Element 1306b. FIG. 13B also schematically presents an NFC Reader 1310b.

FIG. 13C schematically presents a subsystem 1300c comprising an Android device utilizing NFC communication without a physical Secure Element card. This subsystem 1300c includes a Host CPU 1302c and an NFC controller 1304c. FIG. 13C also schematically presents an NFC Reader 1310c.

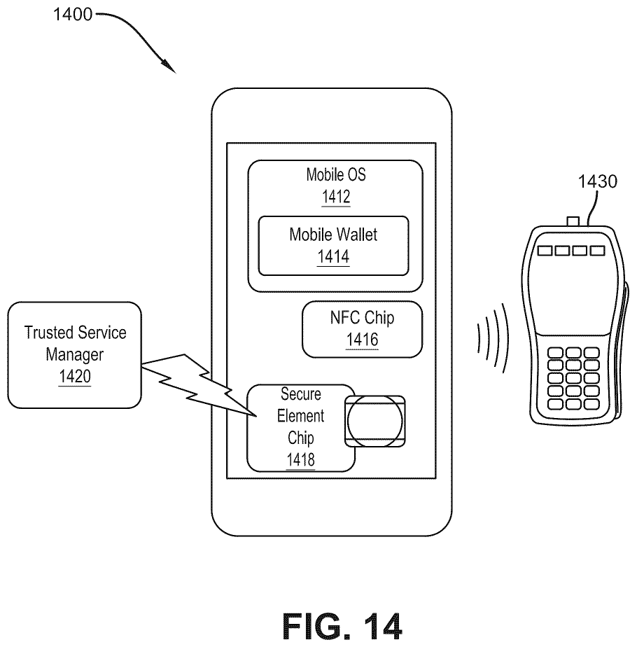

FIG. 14 schematically presents an SE-Based NFC Card Emulation subsystem 1400. This subsystem 1400 includes a Mobile Device 1410, a Trusted Service Manager 1420, and a Card Reader device 1430. The Mobile Device 1410 includes a Mobile OS 1412, an NFC Chip 1416, and a Secure Element Chip 1418. The Mobile OS includes a Mobile Wallet component 1414.

Further details of FIG. 14 will now be described. The Mobile Wallet component 1414 and the Secure Element Chip 1418 share information with one another. The Secure Element Chip 1418 and the NFC Chip 1416 share information with one another. The NFC Chip 1416 communicates with the Card Reader Device 1430 using NFC technology.

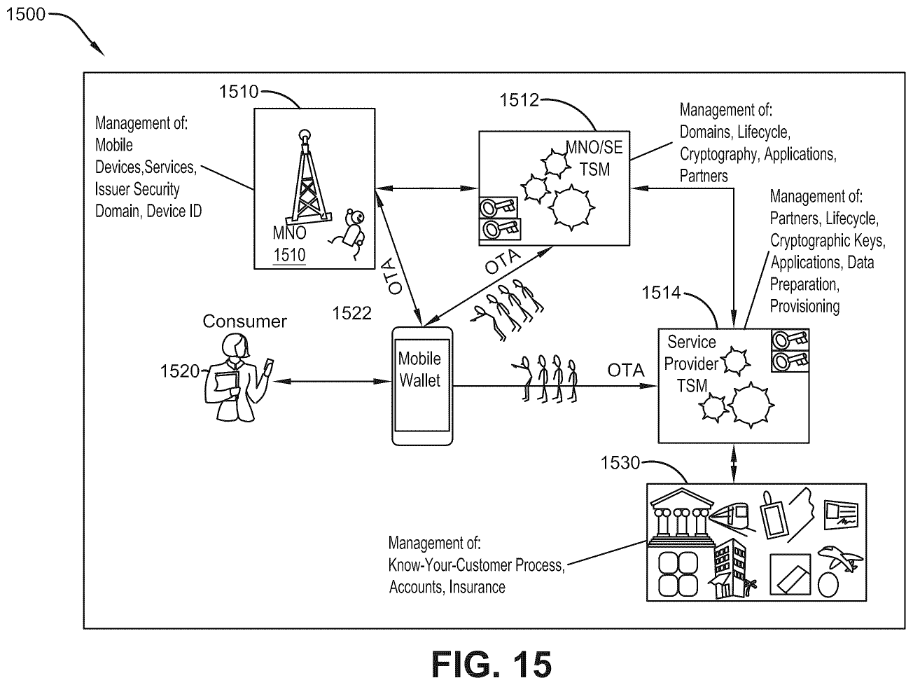

FIG. 15 schematically presents a subsystem 1500 showcasing the use of a TSM to provision credentials to the SE. This subsystem 1500 includes an MNO 1510, an MNO/SE TSM 1512, a Service Provider TSM 1514, a Consumer 1520, a Mobile Wallet 1522, and a PTA 1530.

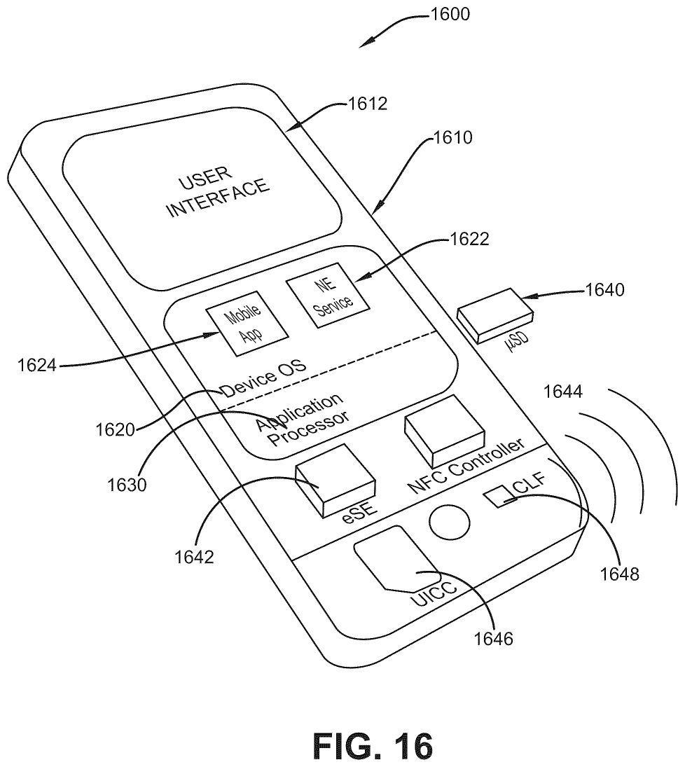

FIG. 16 schematically presents a subsystem 1600 comprising a mobile device showcasing an HCE service with different SE form factors. This subsystem 1600 includes a Mobile Device 1610. This Mobile Device 1610 includes a User Interface 1612, a Device OS 1620, an Application Processor 1630, a Micro-SD Card 1640, an SE component 1642, an NFC Controller 1644, a UICC component 1646, and a CLF component 1648. The Device OS 1620 includes an HCE Service component 1622 and a Mobile AU.S. Plant Pat. No. 1,624.

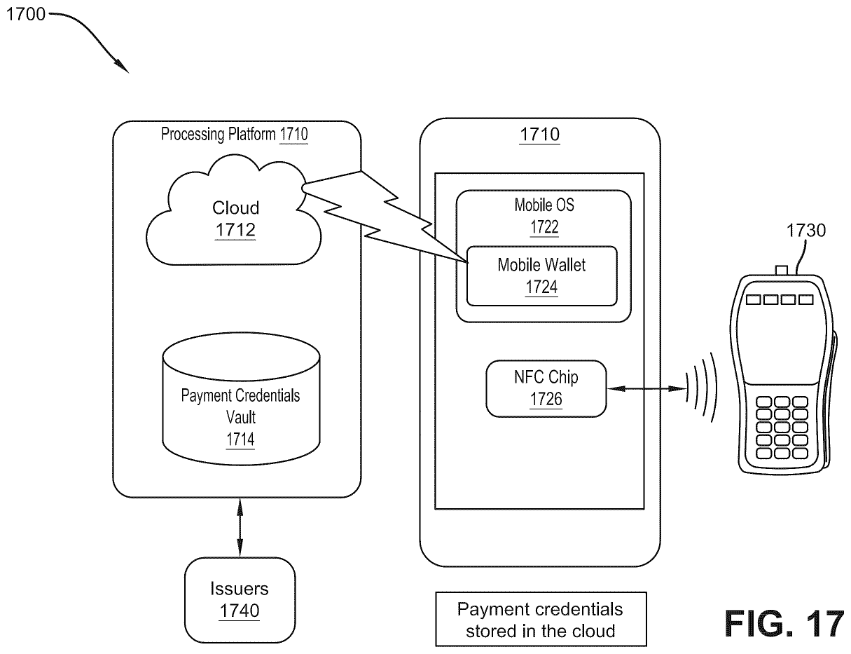

FIG. 17 schematically presents a subsystem 1700 comprising a mobile device showcasing the process of obtaining credentials from the cloud using HCE. This subsystem 1700 includes a Processing Platform 1710, a Mobile Device 1720, a Card Reader device 1730, and Issuers 1740. The Processing Platform 1710 includes a Cloud 1712 and a Payment Credentials Vault 1714. The Mobile Device 1720 includes a Mobile OS 1722 and an NFC Chip 1726. The Mobile OS 1722 includes a Mobile Wallet 1724.

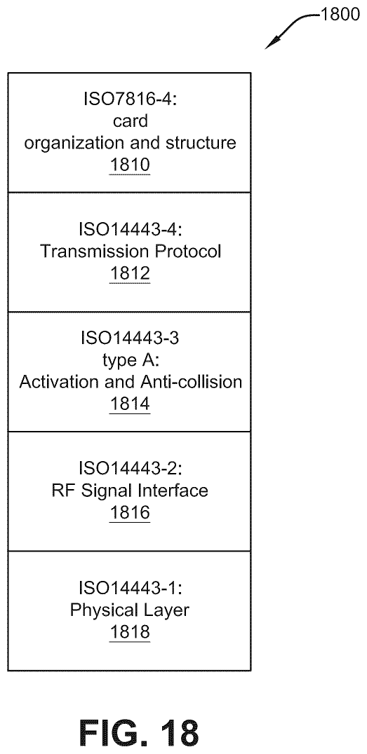

FIG. 18 schematically presents a subsystem 1800 comprising an android HCE protocol stack. This subsystem 1800 includes a Card Organization and Structure component 1810, a Transmission Protocol component 1812, an Activation and Anti-Collision component 1814, an RF Signal Interface component 1816, and a Physical Layer component 1818.

It is to be understood that a user input may be inputted into the system via tapping a touch-screen display, clicking a mouse, or any appropriate user-input method. It is to be understood that as an output, the system may display a graphical user interface (GUI).

It is to be understood that some steps may be executed in more than one of the above described methods, systems, and/or their respective figures. For example, step 202 (FIG. 2) may also be executed at 302 (FIG. 3A) and/or 502 (FIG. 5), step 206 (FIG. 2) may be executed at 306 (FIG. 3A), step 212 (FIG. 2) may be executed at step 314 (FIG. 3A), and/or step 220 (FIG. 2) may be executed at step 320 (FIG. 3A).

As non-limiting examples, an appropriate contactless reader or system may be or may include MiFARE4Mobile technology or sub-systems (e.g. TapLinx SDK), an appropriate customer engagement hub may be or may include BOOMERANG or associated sub-systems, and an appropriate electronic ticketing standard microprocessor for contactless smart cards may be CALYPSO technologies or subsystems.

The application may be configured to allow communication between a mobile phone (or contactless card) and a device reader. For example, successful communication authorizes a registered user to board a subway, train, or bus anywhere in the world.

The disclosed solution may include variations. The core technology may be a mobile application running on a specially configured hardware device, which provides a variety of wireless signals through a cellular phone (mobile device) to connect with readers. By utilizing geolocation (GPS) with a mobile device, the mobile application will be able to determine the user's location in relation to nearby public transportation card readers. Upon close proximity to a smart card reader, the mobile application uses an algorithm to determine an optimal wireless contactless mechanism to access the public transport service. A variation of this technology may be or include a contactless card that can be utilized for fare payments with smart card readers.

A web-based portal may be provided by the system, configured to provide back-office support and provide back-end processing of payments, ticket usage, customer analytics, funding/payment sources, refund services, and customer support. The web-based portal may include a series of dashboards for back-office operations. In addition, the portal may provide concierge services to a traveler to aid them in their journey. The portal may utilize GPS information to deliver tailored content and mobile alerts to the customer or user. Offers and incentives may be pushed to users through web/mobile marketing channels.

The mobile application may be targeted toward any appropriate contactless reader. For example, the mobile application may work with Greenfield readers, or any appropriate technology such as Bluetooth, Bluetooth Low Energy, RFID, WiFi, and/or EMV.

The disclosed system provides an ability to use a mobile phone application to board public transportation on a global basis, and this ability is advantageous compared to having to buy tickets or passes throughout the world for each train, bus, and subway service that is used. There are significant economies of scale that make the disclosed universal fare payment service useful. An improved passenger experience is at the heart of the solution. This technology allows tap-and-go in a contactless fashion to pay for, and then enter, public transportation systems.

As such, the disclosed system implements a GPS locator (e.g. via a GPS receiver at a mobile device) to improve passenger experience and wireless communication technologies to more easily enter public transportation systems in a global fashion. Further, the system may be configured to perform all activities for public transportation on a physical device such as a mobile phone. The system includes a contactless reader subsystem that is configured to interface with Mobile Network Operators (MNOs), or wireless service providers, and provide an interoperable programming interface to remotely provision and manage contactless reading services and configurations in embedded secure elements and/or SIM cards, doing so over the air (OTA). The contactless reader subsystem may comply with international standard ISO/IEC 14443 Type A-a standard used by more than 80% of all contactless smart cards and/or make use of a 13.56 MHz contactless smart card standard. Table 1-1 below lists tag technologies that are supported by the contactless reader subsystem.

| | |
|---|---|
| TagTechnology | The interface that all tag technologies |
| | must implement. |
| NfcA | Provides access to NFC-A (ISO |
| | 14443-3A) properties and I/O |
| | operations. |
| NfcB | Provides access to NFC-B (ISO |
| | 14443-3B) properties and I/O |
| | operations. |
| NfcF | Provides access to NFC-F (JIS 6319- |
| | 4) properties and I/O operations. |
| NfcV | Provides access to NFC-V (ISO |
| | 15693) properties and I/O operations. |
| IsoDep | Provides access to ISO-DEP (ISO |
| | 14443-4) properties and I/O |
| | operations. |
| Ndef | Provides access to NDEF data and |
| | operations on NFC tags that have been |
| | formatted. |
| NdefFormatable | Provides format operations for tags |
| | that may be NDEF formattable. |

(above) Table 1-1

To gain access to a full suite of terminals, other communication protocols may need to be included such as BLE (Low Energy Bluetooth). BLE operates in the 2.4-2.4835 GHz range with 40-2 MHz channels and a reduced power version of BLE may work well with beacons and mobile payments.

NFC technology may be included in the system. NFC deploys electromagnetic induction between two loop antennas in the unlicensed radio frequency ISM band of 13.56 MHz at rates ranging from 106 to 424 Kbit/s. Protocol for communication may be when devices are within 4 cm of each other. NFC may work on an ISO/IEC 18000-3 air interface at rates from 106, 212 or 424 Kbit/s. NFC standards cover communications protocols based on existing radio frequency identification (RFID) standards including ISO/IEC 14443 and FeliCa. Standards also include ISO/IEC 18092 as well as those defined in the NFC Forum and the GSMA NFC standards within mobile devices.

An electronic ticketing standard for microprocessor contactless smart cards (e.g. Calypso) may be included or implemented in the system. For example, the electronic ticketing standard may allow for interoperability between several transport operators in a same area. The electronic ticketing standard may be a standard that originated in Europe and has since extended to Canada, Mexico and South America. The standard may be reliant on a microprocessor smartcard and RFID for the contactless interface. The ticketing standard may be of ISO/IEC 14443 Type B international standard.

An interoperability application dedicated to interoperability may be run by the system, included, and/or implemented. This technology allows the customers to use a portable object (card, sim card, USB key) in all transport networks that are compatible with the interoperability application. The interoperability application provides the means for access to public transit authorities across municipalities in the same interoperable technology. Secured keys of, or that are compatible with the interoperability application may be shared between all operators that are compatible with the interoperability application. As a non-limiting example, the interoperability application may be Triangle by Calypso, or any appropriate sub-system thereof.

A contactless RFID smart card sub-system, used in electronic money cards may be included in the system. Via the contactless RFID smart card sub-system, encryption keys may be generated dynamically during mutual authentication. The contactless RFID smart card sub-system may be in accordance with ISO/IEC 18092 (NFC) having coding at 212 Kbits/s in 13.56 MHz range, and/or communication can occur within 10 cm. The contactless RFID smart card sub-system technology may allow users to add smart cards into their digital wallets and tap their phone to permit access to any appropriate service described herein, or access to transportation services. Users can then transfer balance from a physical smart card to the digital wallet or create a virtual smart card. As a non-limiting example, the RFID smart card sub-system may be FeliCa, or any appropriate sub-system thereof.

To enable the universal fare payment and collection system, all the above described technologies and services may need to be utilized and aggregated such as the contactless reader technology, BLE technology, NFC technology, interoperability application, RFID smart card sub-system, and/or remote ticket purchasing over HTTP in the mobile app. It is to be understood that any appropriate technology may be utilized and aggregated without departing from the spirit and scope of this disclosure.

The disclosed system overcomes the limitations and solves the problems of the prior art by providing a traveler with a way to ride multiple PTAs from a single application. The disclosed system's competitive advantage lies in the ability to aggregate various PTA accounts and provide the riders access to a multitude of transportation authorities without the need for downloading separate mobile apps per PTA.

The disclosed system will include or utilize a variety of technologies to address the shortcomings in the marketplace as described in the background section. There are a multitude of PTAs that exist in the world, each PTA being equipped with their own set of readers and infrastructure that are integrated via and with the disclosed system.

A first step to choosing a correct technology that is needed at a PTA may include determining a location of a user in real time. As a non-limiting example, the disclosed system may make use of native geolocation abilities from an Android device utilizing Google Maps to obtain a “last known location”. Upon obtaining the longitude and latitude of the user when accessing the mobile app, those coordinates will be sent up to a server. Based on a lookup table, the server will send down information related to a particular PTA and what type of communication protocol is required at a given location.

As an example, if a user enters a PTA that requires communication via BLE from the mobile app, a request sent to the server will return to the mobile app all security keys and handshakes required to initiate a bridge to the PTA reader. The reader could also be a contactless reader subsystem reader as described above, in which case the mobile app would utilize a contactless reader mobile SDK for the mobile app to communicate to the reader. The disclosed mobile app may be configured to seamlessly communicate with numerous contactless reader technology readers. As such, a core feature of the system is that it determines which transportation payment technology is to be used at a user's location, and configure the user's device to communicate with a detected payment technology.

One or more of the methods above may include transferring a user's credentials from a contactless reader card into a Secure Element. To allow a user access to a PTA with a contactless reader, those credentials must be first transferred to the Secure Element of the device. This can be done by interfacing with a Trusted Service Hub (TSH). Once contactless reader credentials have been successfully transferred, the rider can simply tap the mobile device against the reader which will transmit the credentials from the Secure Element to the reader. The disclosed mobile app will facilitate an initialization process for a user to transfer the existing contactless reader card into the Secure Element of the device.

The system may be configured to support Host Card Emulation (HCE). Host Card Emulation transfers a physical card into a digital representation. With HCE, the mobile app can make use of the physical card directly from Android code. With Host Card Emulation implemented in the app, the mobile app can communicate with the reader as opposed to having the communication directed to the device's secure element. This would allow the mobile app to gain low level function access to the reader via the Android HCE code.

HCE introduces an option for the NFC controller to now additionally route communication from the contactless reader or POS terminal to an HCE service on the mobile device's host CPU. With HCE, an ‘APDU Service’ running on the host can interface with a contactless reader via NFC. This HCE service can be part of a mobile application with a user interface, such as a mobile wallet for payment. The credentials used by this HCE service can be stored in the application itself, or they could be stored in other secure locations such as a trusted execution environment (TEE) or an SE.

Alternatively, the HCE service could connect in real-time or at given intervals with a back-end server in the cloud to retrieve credentials to exchange with the contactless terminal. Real-time retrieval of credentials from the cloud at the moment of tapping on a reader is a possible but unlikely option, as network latency may result in a poor user experience.

For those PTAs that do not support any of the aforementioned methods to grant access to the rider, the system may be configured to allow direct HTTP integration into the PTA's back office. For PTAs that have made their ticket purchasing process available via HTTP RESTful API calls, the mobile app will integrate into those HTTP calls in order to grant the rider access into the PTA.

As a non-limiting example, there may be only one registered user account allowed per user, however, depending on the specific implementation, the system may merge or leverage existing accounts at other PTAs to provide contactless tap and go access universally.

The server may include, or integrate into a customer engagement hub. For example, the customer engagement hub may help organizations transform their digital business, increasing revenue and customer satisfaction by enabling personalized user experiences and providing organizations a 360-degree view of their customer. With the customer engagement hub in place, the system can establish two-way online communications, provide targeted website offers, add customer-facing services with minimum customization work and stay ready for opportunities as a marketplace evolves. The customer engagement hub integrates sales, billing, e-commerce and

CRM solutions to ensure a consistent customer experience no matter the channel. The customer engagement hub component of the system will deal with credit card needs of users, for adding or refunding monies on the mobile application card, and deal with all the account management that comes along with the management lifecycle of a physical credit card.

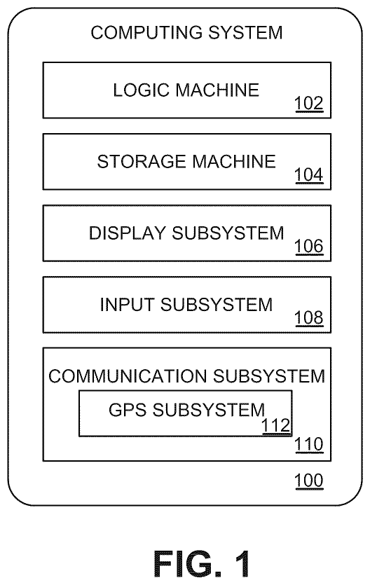

In some aspects the methods, tasks, processes, and/or operations described above may be effected, executed, actualized, and/or carried out by a computing system including a tangible computer-readable storage medium, also described herein as a storage machine, that holds machine-readable instructions executable by a logic machine (i.e. a processor or programmable control device) to effect, execute, actualize, carry out, provide, implement, perform, and/or enact the above described methods, processes, operations, and/or tasks. For example, a suitable computing system may be computing system 100 shown in FIG. 1. When such methods, operations, and/or processes are implemented, the state of the storage machine 104 may be changed to hold different data. For example, the storage machine 104 may include memory devices such as various hard disk drives, CD, or DVD devices. The logic machine 102 may execute machine-readable instructions via one or more physical information and/or logic processing devices. For example, the logic machine 102 may be configured to execute instructions to perform tasks for a computer program. The logic machine 102 may include one or more processors to execute the machine-readable instructions. The computing system 100 may include a display subsystem 106 to display a graphical user interface (GUI) or any visual element of the methods or processes described above. For example, the display subsystem 106, storage machine 104, and logic machine 102 may be integrated such that the above method may be executed while visual elements of the disclosed system and/or method are displayed on a display screen for user consumption. The computing system 100 may include an input subsystem 108 that receives user input. The input subsystem 108 may be configured to connect to and receive input from devices such as a mouse, keyboard or gaming controller. For example, a user input may indicate a request that a certain task is to be executed by the computing system 100, such as requesting the computing system 100 to display any of the above described information, or requesting that the user input updates or modifies existing stored information for processing. A communication subsystem 110 may allow the methods described above to be executed or provided over a computer network. For example, the communication subsystem 110 may be configured to enable the computing system 100 to communicate with a plurality of personal computing devices. The communication subsystem 110 may include wired and/or wireless communication devices to facilitate networked communication. As non-limiting examples, the communication subsystem 110 may include a global positioning system (GPS) module or subsystem 112 that includes one or more GPS receivers for determining a location of one or more electronic devices (e.g. a smart phone). The described methods or processes may be executed, provided, or implemented for a user or one or more computing devices via a computer-program product such as via an application programming interface (API).

The system may provide a pass (e.g. PASSEKO Pass) that allows passengers to access such transportation systems using one pass. For example, the PASSEKO Pass may provide its holder access to multiple private and public transportation systems located within one or more counties, cities, states, countries, and importantly access to public transportation managed and operated by different public transport authorities (PTAs) nationwide and worldwide. PASSEKO may utilize GPS technology and AI engines to determine the user's location in relation to nearby public transportation card readers and to automatically configure the user's electronic device or contactless card to match the technology used by a given public transportation card reader.

Therefore the disclosed system allows global travelers to access various transportation systems in a ubiquitous fashion. This solution enables a global traveler to purchase transportation system services throughout the world using a mobile application or contactless card. The system may utilize contactless access technologies for smart card readers, providing contactless convenience to users.

Travelers are provided access to transit systems including passenger rails, subways, buses, trolleybuses, rapid transit (metro, subway, underground), light rail (tramways), passenger ferries, high-speed rails, taxis, taxicabs, carpooling, drivers for hire, water taxis, cruise ships, rental cars, rental bikes, rental self-driving cars, share taxis, rental yachts (i.e. recreational boats or ships), rental private aircraft, air taxis, and all transportation network companies.

One aspect of the PASSEKO Pass will provide car drivers access to parking and also allow drivers to pay for toll roads (i.e. public or private roadways also known as turnpikes or tollways). Passengers may also be allowed access to commercial aircraft. The PASSEKO Pass may further provide access to libraries, buildings, gated communities, car garages, and banking services, and access to paid events or areas like stadiums, sports arenas, and concerts nationwide and worldwide.

With respect to toll roads, the herein disclosed contactless payment method may include readers as part of a toll road infrastructure to monitor lanes within a roadway. The universal fare payment and collection system or mobile application may integrate with any appropriate technology to listen for a signal that will be sent by way of a contactless reader within a particular area. The universal fare payment and collection system's solution will follow any appropriate communication protocol(s) to integrate with various road telematics vendors that provide existing reader solutions (e.g. Kapsch, Siemens, Thales, and Cubic).

With respect to passenger rails, the universal fare payment and collection system or mobile application will enable rail passengers to use their mobile devices to purchase a railway ticket and use the mobile app as a smart ticket. The ticket may be presented as a QR code on the face of the phone, which may then be received by a conductor who will have a QR reader/scanner to receive a ticket through the system. This configuration may be used with passenger railways that do not have contactless entry gates to board their railway system. When entry gates are utilized, the existing contactless readers or systems will be integrated with the universal fare payment and collection system or mobile application for these passenger rail configurations. In this case, the universal fare payment and collection system mobile application will integrate with a contactless reader through the use of any of the herein described contactless reader technology systems. This will allow entry to the passenger train in a contactless fashion. In addition, the universal fare payment and collection system mobile application can utilize

ApplePay, Android Pay, EMV, facial recognition technology, or other biometric reading technologies, such as fingerprints, retinal scans, voice recognition, and handprint reading technology, as non-limiting examples, in an automated fashion depending on the reader configuration utilized by a railway system. When available, the universal fare payment and collection system mobile application may utilize distance-based pricing. The mobile application may require entry and exit readers to be configured at each stop, to accommodate distance-based pricing for railway travel.

With respect to subways, the contactless reader technology system may provide near field communication (NFC) to support contactless access through the universal fare payment and collection system mobile application to contactless readers or systems utilized within subway systems on a world-wide basis. The universal fare payment and collection system mobile application may utilize this technology to enable riders to board passenger rails when passing through an entry gate having a contactless reader. In addition, the universal fare payment and collection system mobile application can utilize ApplePay, Android Pay, EMV, facial recognition technology, or other biometric reading technologies, such as fingerprints, retinal scans, voice recognition, and handprint reading technology, as non-limiting examples, in an automated fashion depending on a reader configuration utilized by a subway system. When available, the universal fare payment and collection system mobile application may utilize distance-based pricing. The mobile application may require entry and exit readers at each stop, within the transportation system configuration, to accommodate distance-based pricing for subway travel.

With respect to buses, upon entry to a bus, the contactless reader may be positioned near a driver at the front of the vehicle. However, in some cases they may be installed at other entry points on the bus. The contactless reader technology provides near field communication to support contactless access through the universal fare payment and collection system mobile application to contactless readers utilized within buses. In addition, the universal fare payment and collection system mobile application can utilize ApplePay, Android Pay, EMV, facial recognition technology, or other biometric reading technologies, such as fingerprints, retinal scans, voice recognition, and handprint reading technology, as non-limiting examples, in an automated fashion depending on the reader configuration utilized by the bus system. When available, the universal fare payment and collection system mobile application may utilize distance-based pricing. The mobile application may require entry and exit readers at each stop, within the transportation system configuration, to accommodate distance-based pricing for travel by bus.

With respect to trolleybuses, upon entry to a trolley, the contactless readers may be positioned near a driver at the front of the vehicle. However, in some cases they may be installed at other entry points on the trolley. The contactless reader technology provides near field communication to support contactless access through the universal fare payment and collection system mobile application to contactless readers utilized within certain trolleys. In addition, the universal fare payment and collection system mobile application can utilize ApplePay, Android Pay, EMV, facial recognition technology, and other biometric reading technologies, such as fingerprints, retinal scans, voice recognition, and handprint reading technology, as non-limiting examples, in an automated fashion depending on the reader utilized by the trolley operator. In cases where QR code tickets are utilized, then the application will direct the user to purchase the trolley ticket through the mobile app. When available, the universal fare payment and collection system mobile application may utilize distance-based pricing. The mobile application may require entry and exit readers at each stop, within the transportation system configuration, to accommodate distance-based pricing for travel by a trolley.

In respect to metros, subways, or underground rails, the contactless reader technology provides near field communication to support contactless access through the universal fare payment and collection system mobile application to contactless readers utilized within metro systems on a world-wide basis. The universal fare payment and collection system mobile application may utilize this technology to enable riders to board passenger cars when passing through an entry gate having contactless reader. In addition, the universal fare payment and collection system mobile application can utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized by a local metro system. When available, the universal fare payment and collection system mobile application may utilize distance-based pricing. The mobile application may require entry and exit readers at each stop, within the transportation system configuration, to accommodate distance-based pricing for metro travel.

With respect to light rail, tramways, and/or high speed rail the universal fare payment and collection system or mobile application will enable light rail passengers to use their mobile devices to purchase a tram ticket and use the mobile app as a smart ticket. The ticket would be presented as a QR code on the face of the phone, which will then be received by a tram conductor who will have a QR reader/scanner to receive the ticket. This approach may be used with light railways that do not have contactless entry gates for boarding. When entry gates are utilized, the existing contactless readers or systems may be integrated with the universal fare payment and collection system or mobile application for these passenger rail systems. In this case, the universal fare payment and collection system mobile application may integrate with a contactless reader through the use of any of the herein described contactless reader technology systems allowing entry to the passenger train. In addition, the universal fare payment and collection system mobile application can utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized by a light rail system. When available, the universal fare payment and collection system mobile application may utilize distance-based pricing. The mobile application may require entry and exit readers at each stop, within the transportation system configuration, to accommodate distance-based pricing for light rail travel.

With respect to passenger ferries, the universal fare payment and collection system or mobile application will enable ferry passengers to use their mobile devices to purchase a ferry ticket and use the mobile app as a smart ticket. The ticket would be presented as a QR code on the face of the phone, which will then be received by a ferry attendant who will have a QR reader/scanner to receive the ticket. This approach may be used with ferries that do not have contactless entry gates for boarding. When entry gates are utilized, the existing contactless readers or systems will be integrated with the universal fare payment and collection system or mobile application for these passenger ferry systems. This may include NFC, MIFARE4Mobile, BLE, or Bluetooth. In this case, the universal fare payment and collection system mobile application will integrate with a contactless reader allowing entry to the passenger ferry. In addition, the universal fare payment and collection system mobile application can utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized.

With respect to high-speed rail, the universal fare payment and collection system or mobile application will enable high-speed rail passengers to use their mobile devices to purchase a train ticket and use the mobile app as a smart ticket. The ticket would be presented as a QR code on the face of the phone, which will then be received by the conductor, who will have a QR reader to receive the ticket. This approach will be used with railways that do not have contactless entry gates to board high-speed railways. When entry gates are utilized, the existing contactless readers or systems will be integrated with the universal fare payment and collection system or mobile application for these high-speed passenger rail systems. In this case the mobile universal fare payment and collection system or mobile application will integrate with a contactless reader through the use of any appropriate contactless reader technology, allowing entry to the high-speed rail. In addition, the universal fare payment and collection system or mobile application may provide a concierge service that can utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized by the high-speed railway system. When available, the universal fare payment and collection system or mobile application will utilize distance based or geography based pricing. The mobile application will require entry and exit readers at each stop, within the transportation system. This will accommodate distance-based pricing for high-speed rail travel.

With respect to taxicabs, upon entry to a taxicab, the contactless readers tend to be positioned near the rider. The universal fare payment and collection system or mobile application would provide a concierge service that would utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized by the cab and the method of payment by the taxicab operator.

With respect to carpooling or taxipooling, most carpooling groups do not utilize electronic contactless readers. As a result, a branded credit card/debit card of the disclosed universal fare payment and collection system would be utilized and a direct payment would be made to the private driver using that card. That payment may include a service such as Venmo or Zelle for electronic transfer of funds, as non-limiting examples.

With respect to drivers for hire, upon entry to a limousine or private car service, the universal fare payment and collection system or mobile application would provide a concierge service. The application would then direct the user to utilize ApplePay, Android Pay, EMV, facial recognition technology, or other biometric reading technologies, such as fingerprints, retinal scans, voice recognition, and handprint reading technology, as non-limiting examples, in an automated fashion depending on the reader utilized by the driver and the method of payment by the operator. If contactless payments cannot be utilized, then the mobile application will recommend through the concierge service that a branded credit card/debit card of the disclosed universal fare payment and collection system would be utilized and a direct payment would be made to the private driver using that card.

With respect to water taxis, most water taxis do not utilize electronic contactless readers. Upon entry to a water taxi, a branded credit card/debit card of the disclosed universal fare payment and collection system would be utilized and a direct payment would be made to the water taxi using that card. A QR code ticket could be utilized if a QR reader is available, which would typically entail a ticket purchase from within in the mobile app.

With respect to cruise ships, the universal fare payment and collection system or mobile application would utilize ApplePay, Android Pay, EMV, facial recognition technology, other biometric reading technologies, such as fingerprints, retinal scans, voice recognition, and handprint reading technology, or the like in an automated fashion depending on the reader utilized by the cruise ship. When an NFC contactless ticket reader is being utilized, then the universal fare payment and collection system or mobile application could directly interface with the reader being utilized.

With respect to rental cars, the universal fare payment and collection system or mobile application would utilize ApplePay, Android Pay, EMV, facial recognition technology, other biometric reading technologies, such as fingerprints, retinal scans, voice recognition, and handprint reading technology, or the like in an automated fashion depending on the reader utilized by the car rental agency. If contactless payments cannot be utilized, then the universal fare payment and collection system or mobile application will recommend, through a mobile-based concierge service, that the universal fare payment and collection system or mobile application branded credit card/debit card be utilized, and a direct payment would be made to the rental car agency.

With respect to rental bikes, the universal fare payment and collection system or mobile application would utilize ApplePay, Android Pay, EMV, facial recognition technology, other biometric reading technologies, such as fingerprints, retinal scans, voice recognition, and handprint reading technology, or the like in an automated fashion depending on the reader utilized by the rental bike agency. If contactless payments cannot be utilized, then the universal fare payment and collection system or mobile application will recommend, through a mobile-based based concierge service, that the universal fare payment and collection system or mobile application branded credit card/debit card be utilized, and a direct payment would be made to the rental bike vendor.

With respect to rental self-driving cars the universal fare payment and collection system or mobile application includes the ability to utilize wireless communication to secure a self-driving vehicle. The mobile application will utilize Bluetooth, Bluetooth Low Energy, RFID, WiFi, EMV, facial recognition technology, or other biometric reading technologies, such as fingerprints, retinal scans, voice recognition, and handprint reading technology, depending on the configuration requirements of the rental agency and the reader technology that is available.

With respect to share taxis upon entry to a shared taxicab, the universal fare payment and collection system or mobile application would provide a concierge service that would utilize ApplePay, Android Pay, EMV, facial recognition technology, other biometric reading technologies, such as fingerprints, retinal scans, voice recognition, and handprint reading technology, or the like in an automated fashion depending on the reader utilized by the cab and the method of payment by the taxicab operator. If contactless payments cannot be utilized, then the universal fare payment and collection system or mobile application will recommend, through the mobile-based concierge service, that the universal fare payment and collection system or mobile application branded credit card/debit card be utilized, and a direct payment would be made to the taxi operator.

With respect to rental yachts (i.e. recreational boats or ships), for yacht or boat rental, the universal fare payment and collection system or mobile application would provide a concierge service that would utilize ApplePay, Android Pay, EMV, facial recognition technology, other biometric reading technologies, such as fingerprints, retinal scans, voice recognition, and handprint reading technology or the like in an automated fashion depending on the reader utilized by the rental yacht operator and the method of payment by the operator. If contactless payments cannot be utilized, then the universal fare payment and collection system or mobile application will recommend, through the mobile-based concierge service, that the universal fare payment and collection system or mobile application branded credit card/debit card be utilized, and a direct payment would be made to the boat operator.

With respect to rental private aircraft, private aircraft rental would be achieved with the universal fare payment and collection system or mobile application by utilizing ApplePay, Android Pay, EMV, facial recognition technology, other biometric reading technologies, such as fingerprints, retinal scans, voice recognition, and handprint reading technology or the like in an automated fashion depending on the reader utilized by the aircraft owner/operator and the method of payment. If contactless payments cannot be utilized, then the universal fare payment and collection system or mobile application will recommend, through the mobile-based concierge service, that the universal fare payment and collection system or mobile application branded credit card/debit card be utilized, and a direct payment would be made to the aircraft operator.

With respect to buildings (e.g. libraries), rental fees at libraries can be initiated with the universal fare payment and collection system or mobile application utilizing ApplePay, Android Pay, EMV, facial recognition technology, or other biometric reading technologies, such as fingerprints, retinal scans, voice recognition, and handprint reading technology, as non-limiting examples, in an automated fashion depending on the reader utilized and the method of payment. If contactless payments cannot be utilized, then the universal fare payment and collection system or mobile application will recommend, through the mobile-based concierge service, that the universal fare payment and collection system or mobile application branded credit card/debit card be utilized, and a direct payment would be made to the library.

With respect to commercial aircraft the universal fare payment and collection system or mobile application will enable aircraft passengers to use their cellular phone to purchase an airline ticket and use the mobile app as a smart ticket. This may include remote ticket purchasing over HTTP in the mobile app. The ticket would be presented as a QR code on the face of the phone, which will then be received by an airline gate attendant who will have a QR reader to receive the ticket.

With respect to banking services, the universal fare payment and collection system or mobile application branded credit card/debit card can be utilized for banking services. When the availability of contactless readers exists, then the universal fare payment and collection system or mobile application will direct the user to utilize ApplePay, Android Pay, or EMV, facial recognition technology, or other biometric reading technologies, such as fingerprints, retinal scans, voice recognition, and handprint reading technology, or the like in an automated fashion depending on the reader implemented within the bank.

With respect to paid events (e.g. stadiums, sports arenas, or concerts), the universal fare payment and collection system or mobile application will enable event attendees to use their cellular phone to purchase an event ticket and use the mobile app as a smart ticket. The ticket would be presented as a QR code on the face of the phone, which will then be received by the gate attendant for the event. The attendant would have a QR reader to receive/scan the ticket. Other contactless technologies can be utilized by the universal fare payment and collection system or mobile application depending on the reader present at the event. Those contactless configurations can include NFC, BLE, Bluetooth, EMV, facial recognition technology, and other biometric reading technologies, such as fingerprints, retinal scans, voice recognition, and handprint reading technology, as non-limiting examples.

With respect to gated communities, the universal fare payment and collection system or mobile application will enable residents to use their mobile device to enter a gated community. For example, a user may use the mobile app as a remote control or a wirelessly detectable device that is configured to open a gate or door to a community. The gated community may include readers as part of an entry/exit infrastructure to monitor lanes entering and exiting a gate. The universal fare payment and collection system or mobile application may integrate with any appropriate technology to listen for a signal that will be sent by way of a contactless reader within a particular area to operate a gate of the gated community. The universal fare payment and collection system's solution will follow any appropriate communication protocol(s) to integrate with various gated community entry systems.

With respect to garage doors, the disclosed universal fare payment and collection or mobile application will enable residents to use their mobile device to enter a garage. For example, a user may use the mobile app as a remote control or a wirelessly detectable device (e.g. via RFID technology) that is configured to open a garage door. A garage door system may include a receiver that is configured to receive a wireless signal from a mobile device to cause the garage door to selectively or automatically open. Therefore, a garage door system may include a reader that monitors a garage entry way (e.g. driveway). The universal fare payment and collection system or mobile application may integrate with any appropriate technology to listen for a signal that will be sent by way of a contactless reader within a particular area to operate the garage door. The universal fare payment and collection system's solution will follow any appropriate communication protocol(s) to integrate with various garage door systems (e.g. gated access, access control, or access granting technology or systems).

With respect to motorized vehicles, the disclosed universal fare payment and collection or mobile application will enable users to connect to their vehicles via integration with their vehicle's or vehicle manufacturer's mobile application or integrated software, including but not limited to myChevrolet App, FordPass, Mercedes me connect, My MBW App, Toyota App, HondaLink, MyNissan, MyAudi, and OnStar. This will allow users to remotely start their vehicles, check vehicle health reports, maintenance schedules, and other in-vehicle features which are connected to the vehicle's or vehicle manufacturer's mobile application or integrated software.

With respect to home appliances, the disclosed universal fare payment and collection or mobile application will enable users to remotely communicate with all smart home appliances, including but not limited to smart TVs, smart speakers, robot vacuums, video doorbells, smart light bulbs, smart fridges, garage door openers, smart climate control devices. This system will be able to be integrated with virtual assistant technologies, including but not limited to Amazon Alexa, Google Home, and Apple Siri.

With respect to doorbell cameras, the disclosed universal fare payment and collection or mobile application will enable users to access their doorbell camera to either see what the camera is recording live, access a previous recording, or interact with anyone or anything in front or around the doorbell camera via a speaker installed within the doorbell camera's housing unit.

With respect to CCTV cameras, the disclosed universal fare payment and collection or mobile application will enable users to either see what the CCTV camera is recording live or access a previous recording taken by the CCTV camera.

With respect to air taxis, the disclosed universal fare payment and collection or mobile application includes the ability to utilize wireless communication to secure an air taxi. The mobile application will utilize Bluetooth, Bluetooth Low Energy, RFID, WiFi, EMV, facial recognition technology, or other biometric reading technologies, such as fingerprints, retinal scans, voice recognition, and handprint reading technology, as non-limiting examples, depending on the configuration requirements of the rental agency and the reader technology that is available.

With respect to smart air conditioners, the disclosed universal fare payment and collection or mobile application will enable users to interact with and control their air conditioners remotely from their mobile device or other connected device.

This system may also integrate with biometric reading technologies, including facial scanners using face-recognition software. These facial scanners scan people's faces as they walk through the ticketing gate for a given mode public transportation, and uses their faces to identify them and deduct money from their account equal to the cost of the fare. The face-recognition software contains a database of users faces that they have submitted to the system. The system pairs the user's account with their face, allowing the facial scanners to scan a user's face, and then deduct the fare amount from the user's account using the data from the scanner.

Other biometric reading technologies, such as fingerprints, retinal scans, voice recognition, and handprint reading technology.

To connect with the above-described software and devices, the device containing the PASSEKO App will first perform a handshake with the device containing the software with which the PASSEKO App wishes to communicate with or the device which the PASSEKO App wishes to communicate with. Once the handshake process is complete, the devices will be able to communicate with one another.

This system may also include an AI-powered loyalty and/or rewards program, specifically with respect to the carbon consumption of the user. This is to encourage users to monitor their carbon footprint and the carbon they generate based on the type of transportation they utilize.

This system may also integrate AI capabilities and machine learning models to determine both the fastest and cheapest forms of travel using various PTAs.

This system may also integrate autopay capabilities to automatically pay a fare or service fee at each leg of a journey.

This system may also integrate firewall capabilities to prevent double booking on different PTAs, along with preventing the use of the same ticketing technology by one PTA to board multiple PTAs in different locations.

It is to be understood that as referred to herein, the term “ticket” may also refer to a pass or the like, without departing from the scope of this disclosure. Any of the above described ticketing technologies (e.g. NFC technology, contactless card reader technology, or Bluetooth technology) may be referred to as an access granting technology or an access control technology.

Further, it is to be understood that any of the above vehicles (e.g. taxis, carpooling, taxipooling, or self-driving cars) may include a reader inside the vehicles. For example, such a reader may be a co-branded reader specially designed and built to be installed in any of the above vehicles while implementing greenfield projects.

It is to be understood that a mobile device may be any appropriate portable computing device, such as a smart phone, laptop, tablet PC, smart watch, mobile internet devices, wearable computers, personal digital assistants, enterprise digital assistants, handheld game consoles, portable media players, ultra-mobile PCs, and/or smart cards, as non-limiting examples.

Since many modifications, variations, and changes in detail can be made to the described aspects of the present teaching, it is intended that all matters in the foregoing description and shown in the accompanying drawings be interpreted as illustrative and not in a limiting sense. Thus, the scope of the present teaching should be determined by the appended claims and their legal equivalents.

Clause 1: A universal fare payment, fare collection, and smart device integration system, the system including one or more storage machines holding instructions executable by one or more logic machines to: via a user's electronic device, employ an interoperability application to communicate with access control applications/technologies to: schedule, book, plan, and apply applicable discounts to a trip leg by leg via a plurality of different transportation systems; detect a first ticketing technology of a first nearby transportation system for a first leg of the trip utilizing a first specific data type selected from NFC, QR code, Bluetooth technology, BLE technology, GPS, RFID, contactless card technology, facial recognition technology, and other biometric reading technologies, such as fingerprints, retinal scans, voice recognition, and handprint reading technology; configure the user's electronic device for authorizing payment of at least one of a ticket and pass via the first ticketing technology by formatting the user's electronic device to register and handle the first specific data type utilized by the first ticketing technology; at the user's electronic device, via the interoperability application, detect a second ticketing technology of a second nearby transportation system for a second leg of the trip utilizing a second specific data type selected from NFC, QR code, Bluetooth technology, BLE technology, GPS, RFID, contactless card technology, facial recognition technology, and other biometric reading technologies, such as fingerprints, retinal scans, voice recognition, and handprint reading technology, the second ticketing technology being different from the first ticketing technology and the second specific data type being the same as or different from the first specific data type; automatically configure the user's electronic device, with artificial intelligence, for authorizing at least one of a ticket and pass via the second ticketing technology by formatting the user's electronic device to register and handle the second specific data type utilized by the second ticketing technology, at the user's electronic device, use artificial intelligence predictive model analysis to find the fastest and cheapest routes using at least one PTA, at the user's electronic device, use a firewall to prevent double booking and prevent the use of the same ticketing technology by one PTA to board multiple PTAs in different locations, communicate with access control technologies to allow the user to communicate with and open access-controlled doors, gates, and other entryways and exits.

Clause 2: The universal fare payment, fare collection, and smart device integration system of clause 1, wherein the instructions are executable to determine a mobile device protocol.

Clause 3: The universal fare payment, fare collection, and smart device integration system of clauses 1 or 2, wherein the first and second ticketing technologies are one of NFC technology, contactless card reader technology, BLE technology, a Bluetooth technology, facial recognition technology, and other biometric reading technologies, such as fingerprints, retinal scans, voice recognition, and handprint reading technology.

Clause 4: The universal fare payment, fare collection, and smart device integration system of clauses 1-3, wherein the nearby transportation system is determined via a GPS subsystem, wherein a mobile application takes a last known user location, compares it to a database of public transportation authorities (PTAs) and their associated technologies, determines the correct PTA, and sends information regarding the correct communication protocols for that PTA to the user's electronic device.

Clause 5: The universal fare payment, fare collection, and smart device integration system of clauses 1-4, wherein the access control technologies are one of NFC technology, contactless card reader technology, BLE technology, a Bluetooth technology, facial recognition technology, and other biometric reading technologies, such as fingerprints, retinal scans, voice recognition, and handprint reading technology.

Clause 6: The universal fare payment, fare collection, and smart device integration system of clauses 1-5, wherein the user's electronic payment platform is selected from the group including Venmo, Cash App, Zelle, WeChat Pay, Alipay, Samsung Pay, Apple Pay, Google Pay, digital currency, cryptocurrency, central bank digital currency, autopay, and Dwolla.

Clause 7: A universal fare payment, fare collection, and smart device integration system, the system including one or more storage machines holding instructions executable by one or more logic machines to: via a user's electronic device, employ an interoperability application to communicate with electronic toll ticketing technologies to: pay the toll on a toll road, bridge, or tunnel; and via the user's electronic device, connect to the user's bank account or electronic payment platform account to cover the cost of a toll or fare, wherein the nearby toll ticketing technology is determined via a GPS subsystem, wherein a mobile application takes a last known user location, compares it to a database of toll ticketing technologies, determines the correct toll ticketing technology, and sends information regarding the correct communication protocols for that toll ticketing technology to the user's electronic device, wherein the user's electronic device is configured to communicate with said toll ticketing technology via said communication protocol, wherein an artificial intelligence predictive model analyses GPS data from the GPS subsystem and automatically connects the user's bank account or electronic payment platform account with the electronic toll ticketing technologies.

Clause 8: The universal fare payment, fare collection, and smart device integration system of clause 7, wherein the instructions are executable to determine a mobile device protocol.

Clause 9: The universal fare payment, fare collection, and smart device integration system of clauses 7 or 8, wherein the user's electronic payment platform is selected from the group including Venmo, Cash App, Zelle, WeChat Pay, Alipay, Samsung Pay, Apple Pay, Google Pay, digital currency, cryptocurrency, central bank digital currency, autopay, and Dwolla.

Clause 10: The universal fare payment, fare collection, and smart device integration system of clauses 7-9, wherein the device can connect to multiple different toll ticketing technologies in the same trip.

Clause 11: The universal fare payment, fare collection, and smart device integration system of clauses 7-10, wherein the toll ticketing technologies are one of NFC technology, contactless card reader technology, BLE technology, a Bluetooth technology, ETC technology, facial recognition technology, and other biometric reading technologies, such as fingerprints, retinal scans, voice recognition, and handprint reading technology.

Clause 12: A universal fare payment, fare collection, and smart device integration system, the system including one or more storage machines holding instructions executable by one or more logic machines to: via a user's electronic device, employ an interoperability application to communicate with smart home platforms and vehicle applications to: remotely connect to the user's smart home devices and appliances; remotely connect to the user's virtual assistants; remotely connect to the user's motorized vehicle's mobile application; and remotely connect to the user's garage door opener to allow the user to open and close their garage door(s) via this system on their electronic device; via a user's smart home devices and appliances, employ an interoperability application to communicate with smart home platforms and vehicle applications to: remotely connect to the user's other smart home devices and appliances; remotely connect to the user's virtual assistants; remotely connect to the user's motorized vehicle's mobile application; and remotely connect to the user's garage door opener to allow the user to open and close their garage door(s) via this system on their electronic device.

Clause 13: The universal fare payment, fare collection, and smart device integration system of clause 12, wherein the instructions are executable to determine a mobile device protocol.

Clause 14: The universal fare payment, fare collection, and smart device integration system of clauses 12 or 13, wherein the user's virtual assistant is selected from the group including Amazon Alexa, Google Home, Google Nest, and Apple Siri.

Clause 15: The universal fare payment, fare collection, and smart device integration system of clauses 12-14, wherein the system remotely connects to the user's motorized vehicle's mobile application to access remote start capabilities and to check car health reports.

Clause 16: The universal fare payment, fare collection, and smart device integration system of clauses 12-15, wherein the system can remotely connect to multiple different smart home platforms at the same time.

Clause 17: The universal fare payment, fare collection, and smart device integration system of clauses 12-16, wherein the system can remotely connect to multiple different virtual assistants at the same time.

Clause 18: The universal fare payment, fare collection, and smart device integration system of clauses 12-17, wherein the system can remotely connect to multiple different smart home devices at the same time.

Clause 19: The universal fare payment, fare collection, and smart device integration system of clauses 12-18, wherein the system can remotely connect to multiple different motorized vehicle mobile applications at the same time.

Clause 20: The A universal fare payment, fare collection, and smart device integration system of clauses 1-19, further including using artificial intelligence to monitor and calculate carbon consumption by the user.

Non-limiting aspects have been described, hereinabove. It will be apparent to those skilled in the art that the above methods and apparatuses may incorporate changes and modifications without departing from the general scope of the present subject matter. It is intended to include all such modifications and alterations in so far as they come within the scope of the appended claims or the equivalents thereof.

We claim:

1. A universal fare payment, fare collection, and smart device integration system, the system comprising one or more storage machines holding instructions executable by one or more logic machines to:
via a user's electronic device, employ an interoperability application to communicate with access control applications/technologies to:
schedule, book, plan, and apply applicable discounts to a trip leg by leg via a plurality of different transportation systems;
detect a first ticketing technology of a first nearby transportation system for a first leg of the trip utilizing a first specific data type selected from NFC, QR code, Bluetooth technology, BLE technology, GPS, RFID, contactless card technology, facial recognition technology, biometric reading technologies, fingerprints, retinal scans, voice recognition, and handprint reading technology;
configure the user's electronic device for authorizing payment of at least one of a ticket and pass via the first ticketing technology by formatting the user's electronic device to register and handle the first specific data type utilized by the first ticketing technology;
at the user's electronic device, via the interoperability application, detect a second ticketing technology of a second nearby transportation system for a second leg of the trip utilizing a second specific data type selected from NFC, QR code, Bluetooth technology, BLE technology, GPS, RFID, contactless card technology, facial recognition technology, biometric reading technologies, fingerprints, retinal scans, voice recognition, and handprint reading technology, the second ticketing technology being different from the first ticketing technology and the second specific data type being the same as or different from the first specific data type;
automatically configure the user's electronic device, with artificial intelligence, for authorizing at least one of a ticket and pass via the second ticketing technology by formatting the user's electronic device to register and handle the second specific data type utilized by the second ticketing technology;
at the user's electronic device, use artificial intelligence predictive model analysis to find the fastest and cheapest routes using at least one PTA;
at the user's electronic device, use a firewall to prevent double booking and prevent the use of the same ticketing technology by one PTA to board multiple PTAs in different locations; and
communicate with access control technologies to allow the user to communicate with and open access-controlled doors, gates, and other entryways and exits.

2. The universal fare payment, fare collection, and smart device integration system of claim 1, wherein the instructions are executable to determine a mobile device protocol.

3. The universal fare payment, fare collection, and smart device integration system of claim 1, wherein the first and second ticketing technologies are one of NFC technology, contactless card reader technology, BLE technology, a Bluetooth technology, facial recognition technology, biometric reading technologies fingerprints, retinal scans, voice recognition, and handprint reading technology.

4. The universal fare payment, fare collection, and smart device integration system of claim 1, wherein the nearby transportation system is determined via a GPS subsystem, wherein a mobile application takes a last known user location, compares it to a database of public transportation authorities (PTAs) and their associated technologies, determines the correct PTA, and sends information regarding the correct communication protocols for that PTA to the user's electronic device.

5. The universal fare payment, fare collection, and smart device integration system of claim 1, wherein the access control technologies are one of NFC technology, contactless card reader technology, BLE technology, a Bluetooth technology, facial recognition technology, biometric reading technologies, fingerprints, retinal scans, voice recognition, and handprint reading technology.

6. The universal fare payment, fare collection, and smart device integration system of claim 1, wherein the user's electronic payment platform is selected from the group comprising Venmo, Cash App, Zelle, WeChat Pay, Alipay, Samsung Pay, Apple Pay, Google Pay, digital currency, cryptocurrency, central bank digital currency, autopay, and Dwolla.

7. A universal fare payment, fare collection, and smart device integration system, the system comprising one or more storage machines holding instructions executable by one or more logic machines to:
via a user's electronic device, employ an interoperability application to communicate with electronic toll ticketing technologies to:
pay a toll on a toll road, bridge, or tunnel; and
via the user's electronic device, connect to the user's bank account or electronic payment platform account to cover the cost of a toll or fare, wherein the nearby toll ticketing technology is determined via a GPS subsystem, wherein a mobile application takes a last known user location, compares it to a database of toll ticketing technologies, determines the correct toll ticketing technology, and sends information regarding the correct communication protocols for that toll ticketing technology to the user's electronic device, wherein the user's electronic device is configured to communicate with said toll ticketing technology via said communication protocol, wherein an artificial intelligence predictive model analyses GPS data from the GPS subsystem and automatically connects the user's bank account or electronic payment platform account with the electronic toll ticketing technologies.

8. The universal fare payment, fare collection, and smart device integration system of claim 7, wherein the instructions are executable to determine a mobile device protocol.

9. The universal fare payment, fare collection, and smart device integration system of claim 7, wherein the user's electronic payment platform is selected from the group comprising Venmo, Cash App, Zelle, WeChat Pay, Alipay, Samsung Pay, Apple Pay, Google Pay, digital currency, cryptocurrency, central bank digital currency, autopay, and Dwolla.

10. The universal fare payment, fare collection, and smart device integration system of claim 7, wherein the device can connect to multiple different toll ticketing technologies in the same trip.

11. The universal fare payment, fare collection, and smart device integration system of claim 7, wherein the toll ticketing technologies are one of NFC technology, contactless card reader technology, BLE technology, a Bluetooth technology, ETC technology, facial recognition technology, biometric reading technologies, fingerprints, retinal scans, voice recognition, and handprint reading technology.

12. A universal fare payment, fare collection, and smart device integration system, the system comprising one or more storage machines holding instructions executable by one or more logic machines to:
via a user's electronic device, employ an interoperability application to communicate with smart home platforms and vehicle applications to:
remotely connect to the user's smart home devices and appliances;
remotely connect to the user's virtual assistants;
remotely connect to the user's motorized vehicle's mobile application; and
remotely connect to the user's garage door opener to allow the user to open and close their garage door(s) via this system on their electronic device;
via a user's smart home devices and appliances, employ an interoperability application to communicate with smart home platforms and vehicle applications to:
remotely connect to the user's other smart home devices and appliances;
remotely connect to the user's virtual assistants;
remotely connect to the user's motorized vehicle's mobile application; and
remotely connect to the user's garage door opener to allow the user to open and close their garage door(s) via this system on their electronic device.

13. The universal fare payment, fare collection, and smart device integration system of claim 12, wherein the instructions are executable to determine a mobile device protocol.

14. The universal fare payment, fare collection, and smart device integration system of claim 12, wherein the user's virtual assistant is selected from the group comprising Amazon Alexa, Google Home, Google Nest, and Apple Siri.

15. The universal fare payment, fare collection, and smart device integration system of claim 12, wherein the system remotely connects to the user's motorized vehicle's mobile application to access remote start capabilities and to check car health reports.

16. The universal fare payment, fare collection, and smart device integration system of claim 12, wherein the system can remotely connect to multiple different smart home platforms at the same time.

17. The universal fare payment, fare collection, and smart device integration system of claim 12, wherein the system can remotely connect to multiple different virtual assistants at the same time.

18. The universal fare payment, fare collection, and smart device integration system of claim 12, wherein the system can remotely connect to multiple different smart home devices at the same time.

19. The universal fare payment, fare collection, and smart device integration system of claim 12, wherein the system can remotely connect to multiple different motorized vehicle mobile applications at the same time.

20. The universal fare payment, fare collection, and smart device integration system of claim 1, further comprising:
using artificial intelligence to monitor and calculate carbon consumption by the user.
